(19) United States
(12) Patent Application Publication
(10) Pub. No.: US 2026/0133856 A1
(43) Pub. Date: May 14, 2026

(54) Receiver-Side Gating of Agent Systems

(71) Applicant: DeepMind Technologies Limited, London (GB)

(72) Inventors: Florian Nils Hartmann, Zurich (CH); Victor Carbune, Zurich (CH)

(21) Appl. No.: 18/941,715

(22) Filed: Nov. 8, 2024

(51) Int. Cl. G06F 9/54

(52) U.S. Cl. CPC G06F 9/546

(57) ABSTRACT

Systems and methods for gating requests to agent systems provide for: obtaining a query descriptive of a task to be performed by an agent system from a caller agent system; providing the query to a gating mechanism as input; determining to provide the query to the agent system based on an output of the gating mechanism; in response to determining to provide the query to the agent system, communicating the query to the agent system as input to the agent system; and communicating an output from the agent system to the caller agent system.

### FIELD

The present disclosure relates generally to machine learning processes and machine-learned devices and systems. More particularly, the present disclosure relates to systems and methods for receiver-side gating of agent systems.

### BACKGROUND

A computer can receive input(s). The computer can execute instructions to process the input(s) to generate output(s) using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

### SUMMARY

Aspects and advantages of embodiments of the present disclosure will be set forth in part in the following description, or can be learned from the description, or can be learned through practice of the embodiments.

For example, in an aspect, the present disclosure provides for a computer-implemented method of gating requests to agent systems. The computer-implemented method includes obtaining, by a computing system including one or more computing devices, a query descriptive of a task to be performed by an agent system from a caller agent system. The computer-implemented method includes providing, by the computing system, the query to a gating mechanism as input. The computer-implemented method includes determining, by the computing system, to provide the query to the agent system based on an output of the gating mechanism. The computer-implemented method includes, in response to determining to provide the query to the agent system, communicating, by the computing system, the query to the agent system as input to the agent system. The computer-implemented method includes communicating, by the computing system, an output from the agent system to the caller agent system.

In some implementations, the agent system includes a large language model (LLM) or foundation model.

In some implementations, the gating metric includes a confidence score descriptive of confidence that the agent system successfully handled the task described by the query.

In some implementations, the computer-implemented method further includes: determining, by the computing system, one of a first condition or a second condition based on a probabilistic parameter, wherein the computing system has the first condition with a likelihood defined by the probabilistic parameter and the computing system has the second condition if the computing system does not have the first condition; in the first condition, communicating, by the computing system, the query to the agent system as input to the agent system; and in the second condition, providing, by the computing system, the query to the gating mechanism as input.

In some implementations, the method further includes modifying, by the computing system, the probabilistic parameter based on the gating metric.

In some implementations, the computer-implemented method further includes: receiving, by the computing system, data descriptive of a gating metric from the agent system, the gating metric indicative of a correlation between the task of the query and the output of the agent system; and modifying, by the computing system, one or more gating parameters of the gating mechanism based on the gating metric.

In some implementations, the gating mechanism is configured to: obtain a set of representative examples, the set of representative examples being representative of tasks the agent system is able to perform; define a solution space based on the set of representative examples; determine a representation of the query in the solution space; determine a distance between the representation of the query and the set of the representative examples in the solution space; based on the distance satisfying a distance threshold, return a first output indicating that the query is to be provided to the agent system; and based on the distance failing to satisfy the distance threshold, return a second output indicating that the query is not to be provided to the agent system.

In some implementations, determining, by the computing system, to provide the query to the agent system based on an output of the gating mechanism includes receiving the first output from the gating mechanism. In some implementations, the gating mechanism includes a language analysis tool operable to verify that a syntax or a structure of the query conforms to an expected syntax or an expected structure of inputs to the agent system.

In some implementations, the language analysis tool is generated by the agent system.

In some implementations, the gating mechanism includes a machine-learned gating model configured to receive the query as input and output, in response to receiving the query as input, data indicative of whether the agent system is capable of handling the query.

In some implementations, the agent system is configured to provide training data to the machine-learned gating model. In some implementations, the training data includes one or more training examples labeled with data indicative of whether the agent system is capable of handling the training examples.

In some implementations, the one or more training examples are curated from one or more prior queries to the agent system.

In some implementations, the gating mechanism includes an exit listener, the exit listener configured to listen for an early exit message from the agent system in response to a prior related query.

In some implementations, the agent system is configured to provide the early exit message in response to producing an output having a predicted quality that fails to satisfy a predicted quality threshold, and prior to producing a complete output.

In some implementations, the method further includes modifying the gating mechanism based on a current load of the agent system.

In some implementations, the agent system is or includes a receiver agent system.

In some implementations, the method further includes: obtaining, by the computing system, a second query descriptive of a second task to be performed by the agent system from the caller agent system; providing, by the computing system, the second query to the gating mechanism as input; determining, by the computing system, to gate the query from the caller agent system based on an output of the gating mechanism; and in response to determining to provide the query to the agent system, gating, by the computing system, the query to the agent system from being provided as input to the agent system.

For example, in an aspect, the present disclosure provides a computing system. The computing system includes one or more processors and one or more non-transitory, computer-readable media storing instructions that, when implemented, cause the one or more processors to perform operations. The operations include obtaining a query descriptive of a task to be performed by an agent system from a caller agent system. The operations include providing the query to a gating mechanism as input. The operations include determining to provide the query to the agent system based on an output of the gating mechanism. The operations include, in response to determining to provide the query to the agent system, communicating the query to the agent system as input to the agent system. The operations include communicating an output from the agent system to the caller agent system.

In some implementations, the operations further include determining one of a first condition or a second condition based on a probabilistic parameter, wherein the computing system has the first condition with a likelihood defined by the probabilistic parameter and the computing system has the second condition if the computing system does not have the first condition; in the first condition, communicating the query to the agent system as input to the agent system; and in the second condition, providing the query to the gating mechanism as input.

In some implementations, the gating mechanism is configured to: obtain a set of representative examples, the set of representative examples being representative of tasks the agent system is able to perform; define a solution space based on the set of representative examples; determine a representation of the query in the solution space; determine a distance between the representation of the query and the set of the representative examples in the solution space; based on the distance satisfying a distance threshold, return a first output indicating that the query is to be provided to the agent system; and based on the distance failing to satisfy the distance threshold, return a second output indicating that the query is not to be provided to the agent system.

For example, in an aspect, the present disclosure provides one or more non-transitory, computer-readable media storing instructions that, when implemented, cause one or more processors to perform operations. The operations include obtaining a query descriptive of a task to be performed by an agent system from a caller agent system. The operations include providing the query to a gating mechanism as input. The operations include determining to provide the query to the agent system based on an output of the gating mechanism. The operations include, in response to determining to provide the query to the agent system, communicating the query to the agent system as input to the agent system. The operations include communicating an output from the agent system to the caller agent system.

In some implementations, the operations further include determining one of a first condition or a second condition based on a probabilistic parameter, wherein the first condition occurs with a chance defined by the probabilistic parameter and the second condition occurs if the first condition does not occur; in the first condition, communicating the query to the agent system as input to the agent system; and in the second condition, providing the query to the gating mechanism as input.

In some implementations, the operations further include communicating a rejection message from the gating mechanism to the caller agent system.

For example, in an aspect, the present disclosure provides a computer-implemented method for operating a caller agent system. The computer-implemented method includes obtaining, by a computing system including one or more computing devices, input descriptive of a task to be performed. The computer-implemented method includes determining, by the computing system, a first query based on the input descriptive of the task to be performed. The computer-implemented method includes providing, by the computing system, the first query to a receiver agent system. The computer-implemented method includes, in response to providing the first query to the receiver agent system, obtaining, by the computing system, a rejection message indicative of a rejection rationale. The computer-implemented method includes determining, by the computing system, a second query based on the rejection rationale. The computer-implemented method includes providing, by the computing system, the second query. The computer-implemented method includes obtaining, by the computing system, an output responsive to the second query.

In some implementations, providing the second query includes providing, by the computing system, the second query to the receiver agent system.

In some implementations, obtaining the output responsive to the second query includes obtaining, by the computing system, the output from the receiver agent system.

In some implementations, determining the second query based on the rejection rationale includes modifying, by the computing system, a content of the first query based on the rejection rationale.

In some implementations, providing the second query includes providing the second query to a second receiver agent system different from the receiver agent system.

In some implementations, obtaining the output responsive to the second query includes obtaining, by the computing system, the output from the second receiver agent system.

In some implementations, determining the second query based on the rejection rationale includes modifying, by the computing system, a recipient of the first query from the receiver agent system to the second receiver agent system.

In some implementations, determining the second query based on the rejection rationale includes providing, by the computing system, the rejection message to train a machine-learned model used to generate the first query.

In some implementations, determining the second query based on the rejection rationale includes determining, by the computing system, the second query using the machine-learned model and subsequent to training the machine-learned model using the rejection message.

Other example aspects of the present disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles.

### BRIEF DESCRIPTION OF THE DRAWINGS

FIG. 1 is a block diagram of an example computing system for receiver-side gating of agent systems according to example implementations of the present disclosure;

FIG. 2 is a block diagram of an example computing system for receiver-side gating of agent systems according to example implementations of the present disclosure;

FIG. 3 is a block diagram of an example computing system for receiver-side gating of agent systems according to example implementations of the present disclosure;

FIG. 4 is a block diagram of an example computing system for receiver-side gating of agent systems according to example implementations of the present disclosure;

FIGS. 5-10 are flow chart diagrams illustrating example methods according to example implementations of the present disclosure;

FIG. 11 is a flow chart diagram illustrating an example method for training a machine-learned model according to example implementations of aspects of the present disclosure;

FIG. 12 is a block diagram of an example processing flow for using machine-learned model(s) to process input(s) to generate output(s) according to example implementations of aspects of the present disclosure;

FIG. 13 is a block diagram of an example sequence processing model according to example implementations of aspects of the present disclosure;

FIG. 14 is a block diagram of an example technique for populating an example input sequence for processing by a sequence processing model according to example implementations of aspects of the present disclosure;

FIG. 15 is a block diagram of an example model development platform according to example implementations of aspects of the present disclosure;

FIG. 16 is a block diagram of an example training workflow for training a machine-learned model according to example implementations of aspects of the present disclosure;

FIG. 17 is a block diagram of an inference system for operating one or more machine-learned model(s) to perform inference according to example implementations of aspects of the present disclosure;

FIG. 18 is a block diagram of an example networked computing system according to example implementations of aspects of the present disclosure;

FIG. 19 is a block diagram of an example computing device according to example implementations of aspects of the present disclosure; and

FIG. 20 is a block diagram of an example computing device according to example implementations of aspects of the present disclosure.

### DETAILED DESCRIPTION

Generally, the present disclosure is directed to systems and methods for receiver-side gating of agent systems. The agent system(s) can be or can include artificial intelligence (“AI”) agent system(s). The agent system(s) can utilize machine-learned models and/or other AI-enabled systems to help users solve tasks. For instance, an agent system can employ one or more machine-learned models to generate outputs responsive to queries from users. As one example, an agent system can be or can include a computing system including one or more machine-learned models, where the computing system is configured to receive an input (e.g., a prompt) from a user device or caller device and provide an output responsive to the input to the user device or caller device. The agent system can be or can implement a multi-modal agent system (e.g., a multi-modal artificial intelligence agent system). For instance, a multi-modal agent system can process inputs from one or more data modalities. In some implementations, the agent system can be implemented as a “situated agent system.” The term situated agent system refers to a setting in which the agent system shares one or more perceptual inputs with a human user. For example, the situated agent system can receive and process various data inputs, including video, audio, and/or textual data which are also observable by the human user. The agent system can process these inputs to generate responses that are contextually-relevant for the user's physical or digital environment, for example enabling the agent system to generate dialogue or other responses or outputs which assist the user in understanding and/or navigating the environment.

The agent system can incorporate or benefit from a number of different aspects, including: the employment of advanced sequence processing models to enhance dialogue management, the integration of a real-time communication framework to facilitate immediate data exchange, architectural innovations that decouple input tokenization from model deployment, and/or an efficient caching strategy to optimize data flow. Additionally, the present disclosure provides techniques for accessing a user-specific memory layer to produce outputs responsive to user-specific tasks without increasing latency of the agent system.

These and other aspects of the present disclosure enhance the real-time responsiveness and contextual accuracy of the agent system. In particular, by providing advanced data processing architectures and efficient communication frameworks, aspects of the present disclosure improve system performance in dynamic environments. Specifically, the latency of responses from the agent system can be significantly reduced in cases of performing user-specific tasks.

According to one aspect of the present disclosure, some example implementations of the agent system can include or leverage sequence processing models to effectively process and respond to user interactions. For example, these models, such as large-language models (LLMs), foundation models or foundational models, and large-multimodal models (LMMs), can process a wide range of input data types, including textual, audio, and/or visual data. By integrating these diverse data types, the agent system can generate more contextually relevant responses that are configured to the specific situation and environment of the user.

In some implementations, the sequence processing models included in or used by the agent system can be specifically fine-tuned to manage different dialogue settings. This includes both turn-based dialogues, where the interaction follows a structured turn-taking pattern, and open dialogues, where any participant may speak at any time without a predefined turn order. This flexibility allows the agent system to adapt to various conversational scenarios, maintaining fluidity and coherence in its interactions regardless of the dialogue structure.

As agent systems increase in scale and volume, it will become increasingly common for multiple agent systems to communicate with one another to accomplish tasks. For example, a more general agent system may delegate a request from its user to another, more specialized agent system to provide increased output quality to the user. As one example, a general agent system (e.g., an “AI assistant”) that is asked to translate a phrase may refer the translation request to another (e.g., a second) agent system trained specifically to translate between the respective languages of the request. As another example, a general agent system that is tasked with booking travel in a certain area may refer that booking request to a machine-learned travel booking agent system for that area. As another example, a first agent system may refer to a request to a second agent system with one or more privileged connections (e.g., to other agent systems or entities) not available to the first agent system.

Generally, the caller agent system (e.g., the agent system that obtains input from a user) can have an understanding of which receiver agent systems to call. For instance, a caller agent system may confidently call certain receiver agent systems such as popular receiver agent systems and/or receiver agent systems with which the caller agent system was explicitly taught to interact with during training. However, as more agent systems become available, and/or as the behavior of existing agent systems changes over time, it can be difficult for a caller agent system to determine which receiver agent system to call. One potential solution to this problem is for caller agent systems to reach out to multiple receiver agent systems and select the best result from the outputs of the receiver agent systems. At scale, however, this call-first, reason-later approach can lead to significant computing resources being wasted on suboptimal results which may not be used by the caller agent systems. Furthermore, a caller-side reasoning approach would fail to protect a receiver agent system against a barrage of queries from caller agent systems that fail to implement those approaches. Still further, if a receiver agent system is unable to gate queries, it may attempt to nonetheless answer a query it is not able to handle well through significant computing expenditure, such as by using a lengthy internal network or speculative tool calls, which can contribute to a significant time cost in determining the answer. The caller agent system could therefore experience a significant latency in waiting for an answer from the receiver agent system, which may not even provide a useful answer to the caller agent system. This latency could be amplified significantly if the caller agent system reaches out to multiple receiver agent systems, several of which contribute significant latency in attempting to resolve queries that they are not well-equipped to handle.

The present disclosure provides a solution to at least these problems through receiver-side gating of agent systems. For example, a receiver-side gating mechanism can determine whether a receiver agent system will handle or otherwise respond to an incoming query based on the query itself and/or other factors. In some cases, the receiver-side gating mechanism may also be adaptive to changing capabilities of the receiver-side agent systems over time.

More particularly, a gating mechanism can receive a query indicative of a task to be performed by an agent system (e.g., a receiver agent system). The receiver agent system may or may not be capable of performing the task. As used herein, a machine-learned model or agent system is “capable” of performing a task if it can accurately and reliably produce a meaningful output responsive to the task and/or which accomplishes the goal of the task. For example, an agent system trained in English may produce some output in response to a query asking to define a Spanish word, but the output may not accurately reflect the true definition of the word because the model lacks a trained understanding of the Spanish language. For example, the model may output an error result such as “sorry, but I am unable to translate that phrase” and/or may produce a nonsensical result based on an attempt to interpret the phrase. As another example, an agent system trained to book hotel accommodations in Hungary may not have access to adequate data or other real world systems if receiving a query requesting to book a flight to France. In response to the query, the agent system may attempt to and may even succeed in performing some booking action, but the agent system may not have a high degree of confidence in its output.

The gating mechanism can selectively gate queries from caller agent systems. For instance, the gating mechanism can classify whether the call can be handled by the receiver agent system. The gating mechanism can in some implementations classify the query early (e.g., prior to evaluating the query using the receiver agent system), efficiently, and accurately. If the query can be handled, the gating mechanism can allow the query to pass to the receiver agent system. The receiver agent system can handle the query with its full capabilities, e.g., by any machine-learned models and/or any tools associated with the machine-learned model(s).

However, if the query cannot be handled, the query can be rejected or dropped and the receiver agent system can be prevented from evaluating the query. For instance, the agent system will not use potentially computationally expensive evaluation of a machine-learned model to produce an output in response to the query. In some instances, the query may be dropped without notification to the caller agent system. In some instances, a message indicating that the query was rejected may be returned to the caller agent system in place of the output of the receiver agent system. In some instances, the message indicating that the query was rejected may provide some information about why the query was rejected. For example, the system may return a message indicating that the region is not supported in response to a query for booking travel accommodations in a region not serviced by the receiver agent system, or that the language is not supported for a query in a language in which the agent system was not trained, or other suitable rejection message indicative of at least one reason for the rejection of the query. This information may be provided directly by the receiver agent system and/or may be predicted by the gating mechanism based on information about historical queries.

In some implementations, the gating mechanism can have a probabilistic condition for either directly passing the query to the receiver agent system or gating the query. In some instances, this probabilistic condition can be referred to as or controlled using an “epsilon” parameter that controls a tradeoff between exploring the ability of the receiver agent system to handle various queries or query types and exploiting the ability of the gating mechanism to appropriately gate incoming queries. For example, a first condition can correspond to exploration and can occur with probability equal to the epsilon value; a second condition can correspond to exploitation and can occur with probability equal to one minus the epsilon value. The first, exploration-based condition can be useful for building a set of outcomes that assist in demonstrating the capabilities of the handling agent system, including potential failure cases. This set of outcomes can then be used to refine the operations of the gating mechanism. The gating mechanism can therefore assess and modify its own output over time.

In particular, in the first condition, the query can be passed directly to the model agent system (e.g., without being gated). The agent system can attempt to respond to these unfiltered queries, and can determine whether it could or could not handle the queries. The receiver agent system or some other associated feedback system can produce a gating metric indicative of whether the query should or should not have been gated. For instance, the agent system may produce a confidence score descriptive of how a confidence of the agent system (and/or of machine-learned model(s) utilized by the agent system) that the output is responsive to the query. This condition can ensure that at least some unfiltered queries reach the agent system, and the results of these queries can be used to tune the gating mechanism to changes in the capability of the agent system over time. For example, a gating mechanism may initially be configured to gate for a model agent system that lacks the capability to book travel accommodations for a geographic region. If the capability of the agent system is later extended to allow booking in that region, the gating mechanism should ideally allow queries for booking in that region to pass to the agent system, whereas those queries may have been blocked in an earlier iteration of the gating mechanism. By adapting for the capabilities of the agent system over time, the gating mechanism can provide for reflecting the actual capabilities of the agent system without unnecessarily gating otherwise valid queries.

Furthermore, in the second condition, a gating mechanism is actively employed to determine whether to reject the query or pass the query to the agent system. The query can be provided to the gating mechanism as input. The gating mechanism can produce an output based on the query as input. The query can be provided to the receiver agent system or gated based on the output of the gating mechanism.

In some implementations, when a condition occurs in one of the first or second condition, the gating mechanism (or another element of a computing system) can evaluate a probabilistic condition to resolve the probabilistic condition to (e.g., only) one of the first or second condition with a respective probability for each condition. The probabilistic condition may be evaluated by, for example, utilizing a random number generator or other nondeterministic algorithm to resolve the probabilistic condition. For example, in some implementations, a random number generator may produce a value within a range of possible values, with subsets of the range assigned to each of the conditions that may occur upon resolving the probabilistic condition. If the value produced by the random number generator falls within the subset of the range associated with a given condition (e.g., the first condition or the second condition), that condition can occur. Other manners of determining the occurrence of the first condition or the second condition can be employed without deviating from the present disclosure. Still further, it should be understood that the random number generator need not necessarily be truly random. For instance, a random number generator may utilize or execute one or more deterministic algorithm(s) that have quasi-random results, in that the values occur with a relatively predictable frequency and/or the value produced by the algorithm(s) can be different at each execution of the algorithm.

In some implementations, the gating mechanism is configured to obtain a set of representative examples defining or residing within a solution space over one or more indices. The set of representative examples can be representative of tasks the receiver agent system is able to perform. For example, the receiver agent system can curate the representative examples in the solution space from past queries that were successfully handled by the agent system. As another example, the representative examples can be or can include training data provided to the agent system. To gate a query, the gating mechanism can determine a representation of the query in the solution space, determine a distance between the representation of the query and the set of the representative examples in the solution space, and, based on the distance, determine whether the query should be accepted or rejected. For instance, the distance may be compared to a distance threshold, and the query may be rejected if the distance fails to satisfy the distance threshold.

In some implementations, the gating mechanism can include a language analysis tool operable to verify that a syntax or a structure of the query conforms to an expected syntax or an expected structure of inputs to the receiver agent system. For instance, in some implementations, the receiver agent system can create a tool to analyze the structure of the query. As one example, a receiver agent system trained to perform mathematical operations can create a tool to check that the syntax of the query generally resembles an equation or mathematical problem. As another example, a receiver agent system configured to evaluate computer code or data, formal text, or other data that conforms to one or more conventions, structures, and/or syntaxes can create a tool to verify that the query conforms to the conventions, structures, and/or syntaxes that the receiver agent system is trained to evaluate.

In some implementations, the gating mechanism can include a machine-learned gating model. The machine-learned gating model may be smaller than the machine-learned model(s) of the receiver agent system. For example, the gating model may require fewer computing resources to operate than the receiver agent system. The machine-learned gating model can be configured to receive the query as input and output, in response to receiving the query as input, data indicative of whether the query should be provided to the receiver agent system.

In some implementations, the gating mechanism can include an exit listener. The exit listener can be configured to listen for an early exit message from the agent system in response to a prior related query. For example, the agent system can be configured to provide the early exit message in response to producing an output having less than a desired predicted quality and prior to producing a complete output. As one example, the agent system may produce the early exit message if it recognizes that a confidence score associated with the prediction has dropped below a confidence threshold. The early exit message can be used to gate subsequent related queries based on the prior related query. For example, if the prior related query is earlier in a longer series of related queries to the agent system, the gating mechanism can gate some or all of the related queries in the series. In some implementations, the gating mechanism may produce a probabilistic estimate over a sequence of queries to predict a likelihood of the sequence of calls becoming suitable for processing by the receiver agent system. The probabilistic estimate can be used to gate or allow the sequence of calls (e.g., by allowing the calls if the probabilistic estimate satisfies a range or threshold).

As one example, in some implementations, a computer-implemented method of gating requests to agent systems can include obtaining, by a computing system including one or more computing devices, a query descriptive of a task to be performed by an agent system from a caller agent system. The method can include, in a first condition, communicating, by the computing system, the query to the agent system as input to the agent system. The method can include, in a second condition: providing, by the computing system, the query to a gating mechanism as input; determining, by the computing system, to provide the query to the agent system based on an output of the gating mechanism; and, in response to determining to provide the query to the agent system, communicating, by the computing system, the query to the agent system as input to the agent system. The method can include receiving, by the computing system, an output from the agent system and data descriptive of a gating metric, the gating metric indicative of a correlation between the task of the query and the output of the agent system. The method can include modifying, by the computing system, one or more gating parameters of the gating mechanism based on the gating metric. The method can include communicating, by the computing system, the output from the agent system to the caller agent system.

Example aspects of the present disclosure provide a number of technical effects and benefits, including improvements to computing technology. As one example, determining whether or not to provide a query to an agent system based on a receiver-side gating mechanism can reduce computing resource usage associated with processing queries that an agent system is not capable of adequately evaluating. As the agent system ecosystem continues to rapidly scale, these computing resource savings can provide a significant reduction in wasted computing resources, energy, and bandwidth.

Furthermore, the receiver-side gating mechanism described herein can provide for reduced latency to caller agent systems. For example, determining to provide a query to a receiver agent system based on an output of a gating mechanism (e.g., which may be evaluated significantly faster than an output of the receiver agent system, as described herein) can provide for significantly reduced latency in at least instances where the receiver agent system would be unable to handle the query well and the query is gated by the gating mechanism. For instance, if the systems and methods described herein provide for determining not to provide the query to a receiver agent system, the systems and methods described herein can provide for conserving wasted computing resources that otherwise would have been used in evaluating the query at the receiver agent system. Furthermore, the gating mechanism can provide minimal to no increase in latency in cases where the output is provided to the receiver agent system.

Furthermore, the inclusion of a probabilistic condition to determine whether to provide a query directly to a receiver agent system or gate the query by a gating mechanism and modifying one or more gating parameters of the gating mechanism based on a gating metric output by the receiver agent system can provide for the gating mechanism to adapt to changing capabilities of the receiver agent system over time. For instance, because queries are passed indiscriminately at some random chance, the gating mechanism will ensure that a particular type of queries is not completely blocked from the agent system, such that the system can reevaluate the performance of the agent system on those queries if the agent system later improves its capability to handle those queries.

Various example implementations are described herein with respect to the accompanying Figures.

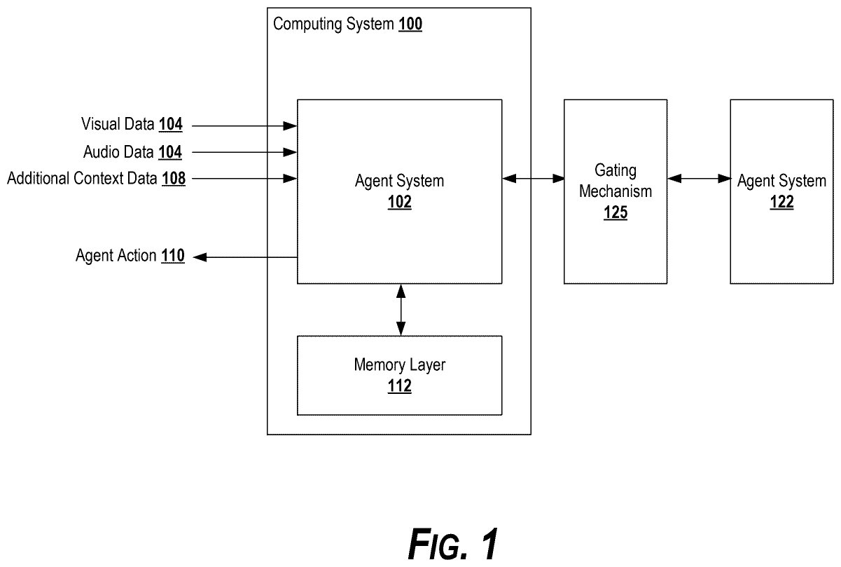

FIG. 1 illustrates an example computing system 100 configured to implement a real-time multi-modal agent system 102 according to example implementations of aspects of the present disclosure. The depicted computing system 100 is designed to receive multiple types of input data, process this data, and generate outputs that are responsive to the inputs in a contextually appropriate manner.

The agent system 102 within the computing system 100 is configured to receive visual data 104, audio data 106, and additional context data 108. Each type of data is processed by the agent system 102 to facilitate interaction within its operational environment. For example, visual data 104 can include live video streams from a camera or recorded video streams from a web resource, while audio data 106 can include spoken commands or ambient sounds captured by microphones.

Additional context data 108 can include sensor data, textual information, or other forms of digital data that provide further insights into the environment or the context of the interaction. As one example, the additional context data 108 can include sensor data that captures user inputs beyond speech inputs, such as touch-screen inputs, gestures, facial expressions, and/or other inputs. These user inputs can, in some implementations, be merged with other inputs such as visual data 104 to create combined inputs. In one example, a user can be provided with an interface that displays a real-time field of view of the agent (e.g., which may correspond to visual data 104). The interface can enable the user to “draw” on or otherwise interact with the interface to mark up the real-time field of view. For example, the user could draw an arrow or make a circle to identify a particular object included within the scene displayed on the interface. The user's graphical input can be added onto or merged with the visual data 104 to form a combined input. For example, the visual data 104 can be amended to include the arrow or circle, which can then be processed by the agent system 102. In such manner, interactive interfaces can provide the ability for the user to more granularly interact with or identify portions of the environment when querying the agent system 102.

Furthermore, it should be appreciated that in some cases the user will be able to control the type, nature, content, or other characteristics of the visual data 104, audio data 106, and/or additional context data 108. As one example, the user can manipulate a field of view of a camera to alter the content of the visual data 104 that is provided to the agent system 102. Similarly, by speaking into a microphone, the user can provide additional audio data 106 as an input for the agent system 102. The agent's ability to process and combine visual, auditory, and textual information allows it to generate more comprehensive and nuanced responses, carefully tailored to the user's multi-modal context.

The agent system 102 processes these diverse inputs to generate an agent action 110, which can include an output designed to respond to the processed inputs effectively. As examples, this action can range from textual responses, vocal responses, displaying information, controlling connected devices, or any other form of interaction output that is deemed appropriate based on the input data. Specifically, the agent system 102 can provide concise answers, generate detailed explanations, offer step-by-step instructions, display information through visual highlights or augmented reality overlays, control connected devices, and/or other forms of actions 110.

In some implementations, the agent system 102 can include and use specialized sequence processing models to integrate and analyze the input data. These models are configured to process complex patterns across different data modalities, enabling the agent system 102 to generate more accurate and contextually relevant responses. The sequence processing models may be specifically fine-tuned to handle various interaction dynamics, such as turn-based dialogues or more open-ended conversational formats, enhancing the flexibility and adaptability of the agent.

Furthermore, the computing system 100 can be connected to a real-time communication framework that facilitates the immediate and efficient exchange of data, including the inputs and outputs to and from the agent system 102. This configuration reduces latency in data processing and response generation.

In some implementations, the agent system 102 can include or have access to a memory layer 112 or other memory system. As an example, for immediate processing needs, volatile memory such as Random Access Memory (RAM) can be used. As another example, for the purpose of long-term data retention, non-volatile storage solutions such as Hard Disk Drives (HDDs) or Solid-State Drives (SSDs) can be used. Furthermore, the memory layer 112 can include hybrid memory solutions that combine the rapid access capabilities of RAM with the extensive storage capacity of disk storage, thereby optimizing the performance of the agent system 102 across various tasks.

The agent system 102 can store and retrieve various types of information to and from the memory layer 112. For example, the agent system 102 can store past interactions, observations, preferences, and/or information from the environment in the memory layer 112. The agent system 102 can then recall this information for use in generating new predictions, outputs, or agent actions.

A number of different types of data can be stored in the memory layer 112. One example of data stored within the memory layer 112 can include object detections. This can include indexed records of objects that the agent encounters during its operations, complete with metadata such as timestamps, location coordinates, and/or contextual tags. By archiving these detections, the agent system 102 can recognize and recall objects from a “history” of observed scenes. The agent system 102 can leverage this information to refine interactions and bolster situational awareness, potentially spanning different sessions of user interaction.

As another example data type, the memory layer 112 can store embeddings of observed visual content, textual content, or other inputs. These embeddings can be low-dimensional numerical representations that encode the essential features of input data into a latent embedding space. The storage of embeddings associated with observed inputs allows the agent system 102 to conduct rapid comparisons and recognition tasks efficiently. In particular, these embeddings, which can be derived from various layer(s) of the agent's machine-learned models, can be used to perform similarity searches to facilitate quick data retrieval.

As another example, intermediate model activations can be stored in the memory layer 112. Capturing and preserving the state of model activations at various stages can enable the agent system 102 to efficiently resume or adjust its processing activities as needed. This feature can be used in scenarios involving long-running or complex processing tasks that may be interrupted or require dynamic adjustments such as resetting the agent to a prior state associated with a prior time.

As another example, the memory layer 112 can store raw tokens generated by the agent's natural language processing, image processing, or other tokenization mechanisms. For example, a cache of tokens can be stored, with each being associated with a specific timestamp. This data allows for the reconstruction of the sequence of inputs and internal states over time, which can be used to retrieve and replay perceptual inputs associated with a particular timestamp or setting, or to otherwise provide the raw tokens as a contextual input for a later prediction.

By maintaining a repository of these data types, the agent system 102 can be equipped with a knowledge base that supports advanced functionalities such as context-aware computing, personalized interactions, and information retrieval from past observations. For example, upon retrieving stored information from the memory layer 112, the agent system 102 can integrate the retrieved data into the current processing workflow. This integration can include aligning historical and current data to enhance the accuracy and relevance of the output.

In some implementations, the agent system 102 can include or have access to both short-term and long-term memory components. The short-term memory may be volatile, designed for the temporary storage of recent interactions and sensory inputs. In contrast, the long-term memory may be non-volatile, storing valuable learned information, user preferences, historical interaction data, and significant environmental events for longer-term recall and usage. In addition, the design of the memory layer 112 can accommodate both structured and unstructured data.

In some implementations, the memory layer 112 can be or include some or all of a context window of one or more machine learning models included in the agent system 102. For example, the memory layer 112 can store a video that is loaded into the context window of a multi-modal machine-learned model included in the agent system 102. The context window can be input into and processed by the machine-learned model to generate a model output from the machine-learned model.

In some implementations, the agent system 102 can employ contextual memory retrieval mechanisms. These mechanisms can include analyzing the current context or environment to determine the most relevant information to retrieve from memory layer 112. For instance, recognizing that the user is in a previously-visited location may trigger the retrieval of relevant past interactions or preferences specific to that location.

In some implementations, the agent system 102 utilizes indexing and search algorithms to categorize memory based on various parameters such as date, location, interaction type, and content relevance. This structured approach enables quick searches and retrieval of pertinent information without delays. The agent's memory management can be dynamic, with continuous updates of new information and/or periodic deletion of outdated or irrelevant data to optimize memory usage and performance.

The ability of the agent system 102 to store information to and retrieve information from the memory layer 112 enables a more sophisticated and personalized user experience. The memory layer 112 enables the agent system 102 to provide contextually-relevant responses based on historical data and interactions, enhancing user engagement and satisfaction.

To provide an example application of the proposed memory capabilities, a user can ask the agent system 102 to recall the location of an object that was previously within the agent's field of view. The agent system 102 can identify the location of the object, referencing its position relative to other objects in the scene. Thus, the agent system 102 can store and retrieve a history of visual observations and utilize this information to answer user queries.

The agent system 102 can be in communication with another agent system 122. The agent system 122 can share aspects discussed with reference to the agent system 102. For example, the agent system 122 can act as a caller agent system configured to provide a request and receive outputs or actions (e.g., agent actions 110) from the agent system 102. The agent system 102 can similarly act as a receiver agent configured to receive a query descriptive of a task to be performed by an agent system from a caller agent system (e.g., the agent system 122) and/or communicate outputs (e.g., agent actions 110) to the caller agent system (e.g., the agent system 122).

According to example aspects of the present disclosure, the computing system 100 can include a gating mechanism 125. The gating mechanism 125 can determine whether a receiver agent system will handle or otherwise respond to an incoming query based on the query itself and/or other factors. For instance, the gating mechanism 125 can be configured to selectively gate queries, calls, or other communications from caller agent systems (e.g., the agent system 122). For instance, the gating mechanism 125 can classify whether the call can be handled by the receiver agent system (e.g., the agent system 102). The gating mechanism can in some implementations classify the query early (e.g., prior to evaluating the query using the receiver agent system), efficiently, and accurately. If the query can be handled, the gating mechanism 125 can allow the query to pass to the receiver agent system (e.g., the agent system 102). The receiver agent system (e.g., the agent system 102) can handle the query with its full capabilities, e.g., by any machine-learned models and/or any tools associated with the machine-learned model(s). It should be understood that the agent system 122 may in some implementations instead be a receiver agent system and the agent system 102 may be a caller agent system.

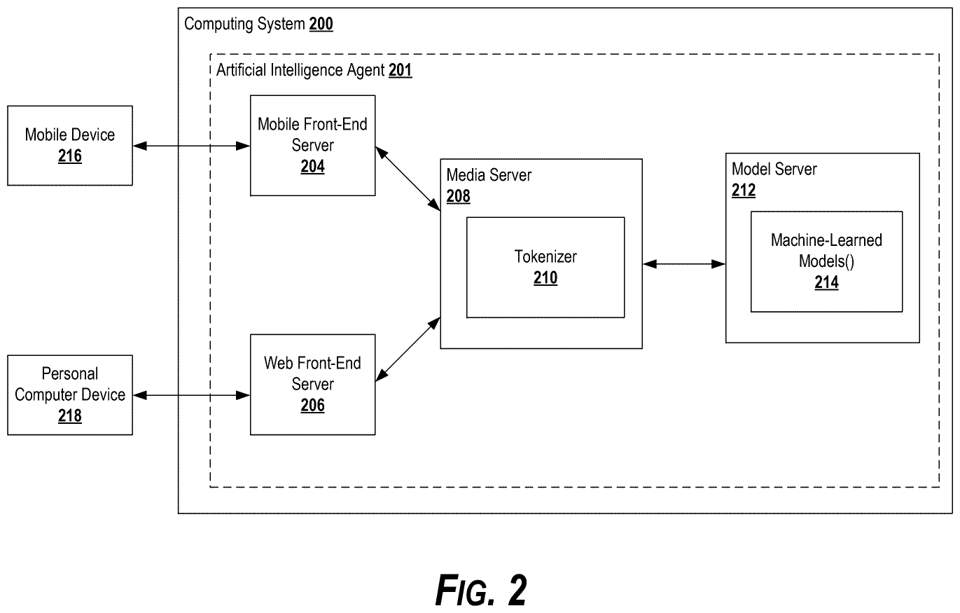

Referring now to FIG. 2, a block diagram illustrates an example computing system 200 configured to implement a real-time multi-modal agent system 201, according to example implementations of aspects of the present disclosure.

The agent system 201, which is implemented by the computing system 200, can be configured to interface with different types of client devices, including mobile device 216 and personal computer device 218. These devices can send and receive data to and from the agent 201, allowing for a dynamic interaction between the user and the agent.

The computing system 200 includes several components that facilitate the operation of the agent system 201. The mobile front-end server 204 and the web front-end server 206 represent the interfaces through which mobile and web-based interactions respectively occur. These servers manage the initial reception of input data from the mobile device 216 and the personal computer device 218, preprocessing this data as necessary before forwarding it to the media server 208.

The media server 208 can act as a central hub within the architecture, receiving processed inputs from both the mobile front-end server 204 and the web front-end server 206. One of the functions of the media server 208 can be to manage the flow of multimedia data, such as video and audio streams, which serve as inputs for the multi-modal capabilities of the agent 201.

The media server 208 can include a tokenizer 210. The tokenizer 210 can operate to process the incoming multimedia data. For example, the tokenizer 210 breaks down complex data streams into manageable tokens, which are simpler data units that can be more easily processed by machine learning models.

From the media server 208, these tokens are then transmitted to the model server 212, which includes and runs one or more machine-learned models 214. These models 214 are responsible for analyzing the tokens to generate responses that are contextually-appropriate based on the input data. The model server 212 operates asynchronously with the tokenizer 210, ensuring that the tokenization process does not delay the response generation, thus maintaining low latency and high responsiveness of the agent 201. Stated differently, the timing of the operations of the tokenizer 210 and the model server 212 can in general be established with less interdependence than if the operations of the tokenizer 210 and the model server 212 were sequentially performed by the same machine or machine cluster.

The architecture illustrated in FIG. 2 supports the efficient processing of data by decoupling the roles of front-end processing and model execution. This decoupling allows the system to optimize performance by parallelizing tasks and minimizing the processing time from input reception to response generation. The use of separate servers for handling different aspects of the data flow—front-end interaction, media processing, and model inference—enhances the system's ability to scale and manage large volumes of interactions simultaneously.

Furthermore, in some implementations, the mobile front-end server 204 and the web front-end server 206 can be specifically configured to support WebRTC protocols or other real-time communication frameworks. This configuration allows these servers to establish peer-to-peer connections with the client devices, facilitating direct data transfer paths that bypass traditional server relay methods. By using WebRTC, the system minimizes the latency typically associated with data transmission over the internet, enhancing the responsiveness of the agent 201.

Additionally, the media server 208 can be equipped with specialized software components that handle the WebRTC streams. These components can include signal processing units that manage the real-time encoding and decoding of video and audio streams, ensuring that the data remains synchronized and maintains high quality throughout the transmission process. The integration of these components allows the media server 208 to efficiently manage the flow of multimedia data, preparing it for further processing by the tokenizer 210 and eventually the model server 212.

In the architecture illustrated in FIG. 2, the term “server” encompasses a broad range of configurations, each potentially comprising one or more machines. This includes setups where a server may represent a cluster of machines working collectively to handle specific tasks or workloads. Additionally, the machines involved in such configurations can be either physical machines, consisting of tangible hardware components, or virtual machines, which operate within a controlled software environment on a physical server.

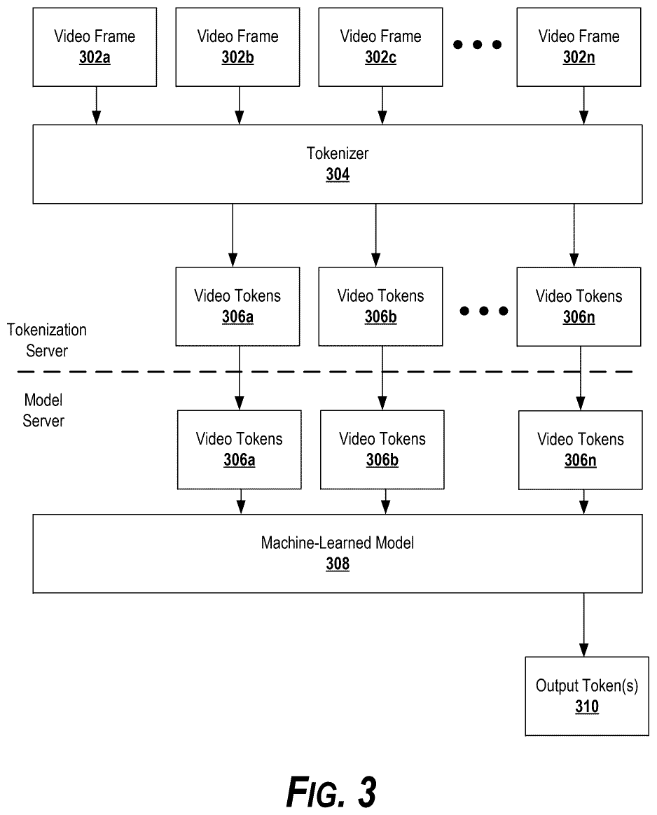

Referring now to FIG. 3, a block diagram illustrates the decoupled tokenization and model execution approach, according to example implementations of aspects of the present disclosure. This diagram illustrates the structured flow of data processing from the initial reception of video frames to the generation of output tokens by the machine-learned model.

The process begins with multiple video frames, labeled as video frame 302a, video frame 302b, video frame 302c, . . . , through video frame 302n. These frames represent a sequence of visual data captured over time, which may be sourced from cameras or other digital video capturing devices or from recorded video media. Each video frame undergoes processing by a tokenizer 304, which is responsible for converting the complex video data into a more manageable form known as video tokens.

These video tokens, depicted as video tokens 306a, video tokens 306b, video tokens 306n, and so forth, represent a tokenized version of the original video frames. The types of tokens generated can vary significantly depending on the specific requirements and configurations of the system.

One possible type of token is an image patch token. In this approach, each video frame is divided into smaller, fixed-size patches. These patches are then individually tokenized, preserving spatial information while reducing the overall complexity of the data.

Another advanced token type is embeddings produced by a machine-learned encoder. In particular, in some implementations, the tokenizer 304 can include a pre-trained neural network or other learned encoder that processes each video frame or patches thereof to produce a dense vector representation, or embedding. These embeddings can then serve as the tokens that are output from the tokenizer 304. These embeddings can capture high-level features of the visual data, such as textures, shapes, and possibly semantic information, depending on the training data and model architecture used.

The operations performed by the tokenizer 304 can range from simple linear projections to more complex non-linear functions. Linear projection involves mapping the high-dimensional video data into a lower-dimensional space using a linear transformation. Non-linear tokenization functions, such as those implemented using neural networks with activation functions like ReLU or sigmoid, allow for a more nuanced transformation of the video data.

The configuration of the tokenizer 304 can be adjusted based on the specific needs of the application. For instance, in scenarios where real-time processing is critical, the tokenizer might be optimized for speed, potentially at the expense of some detail or accuracy. Conversely, in applications where precision is preferred, the tokenizer might employ more sophisticated, computationally intensive techniques to ensure the highest quality tokens.

Once tokenized, the video tokens are forwarded to a model server, which houses the machine-learned model 308. The model server runs the machine-learned model 308 to process the video tokens to generate output token(s) 310. These output tokens represent the actionable data or decisions derived from the video tokens'analysis. They can be used to trigger responses or actions in the system that uses the artificial intelligence agent, such as sending alerts, initiating communication with the user, or adjusting the operation of connected systems based on the content observed in the video frames.

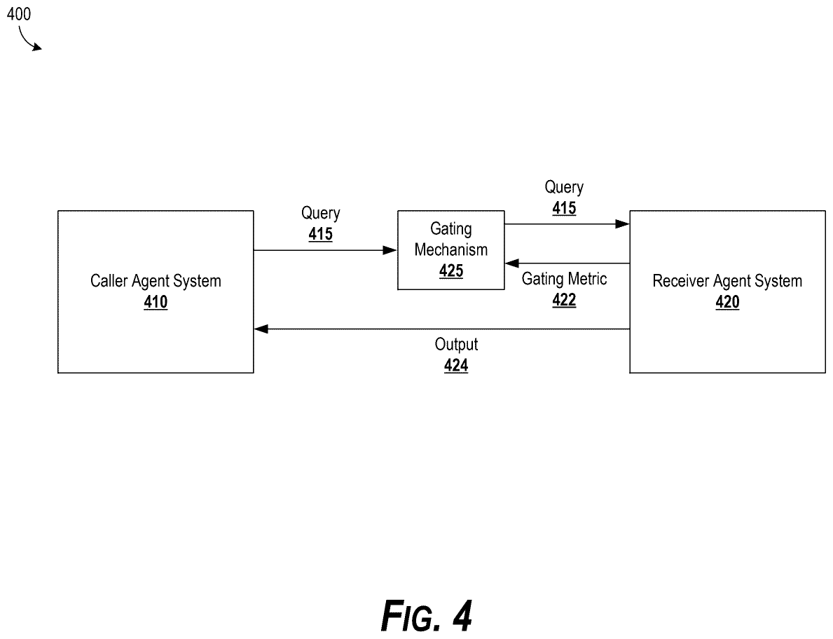

FIG. 4 illustrates an example computing system 400 for receiver-side gating of agent systems according to example implementations of aspects of the present disclosure. In particular, the computing system 400 can include a caller agent system 410 and a receiver agent system 420. Furthermore, the computing system 400 can include a receiver-side gating mechanism 425. The gating mechanism 425 can determine whether the receiver agent system 420 will handle or otherwise respond to an incoming query 415 based on the query itself and/or other factors. In some cases, the receiver-side gating mechanism 425 may also be adaptive to changing capabilities of the receiver agent system 420 over time. If the receiver agent system 420 is capable of handling the query 415, the system 400 can communicate an output 424 from the receiver agent system 420 to the caller agent system 410. For instance, the output 424 can be responsive to the query 415.

In the example of FIG. 4, the gating mechanism 425 is illustrated as separate from the receiver agent system 420. It should be understood that, in some implementations, some or all of the functionality described with respect to the gating mechanism 425 may additionally and/or alternatively be associated with the receiver agent system 420. For instance, in some implementations, the gating mechanism 425 may be incorporated as a component of the receiver agent system 420. As one particular example, in some implementations, the gating mechanism 425 may be or may include one or more layers of a model associated with or operable by the receiver agent system 420.

More particularly, the gating mechanism 425 can receive the query 415 indicative of a task to be performed by the receiver agent system 420. The receiver agent system 420 may or may not be capable of performing the task. The gating mechanism 425 can selectively gate queries from caller agent system 410, especially from a plurality of caller agent systems 410. For instance, the gating mechanism 425 can classify whether the call can be handled by the receiver agent system 420. The gating mechanism 425 can in some implementations classify the query 415 early (e.g., prior to evaluating the query 415 using the receiver agent system 420), efficiently, and accurately. If the query 415 can be handled, the gating mechanism 425 can allow the query 415 to pass to the receiver agent system 420. The receiver agent system 420 can handle the query 415 with its full capabilities, e.g., by any machine-learned models and/or any tools associated with the machine-learned model(s).

However, if the query 415 cannot be handled, the query 415 can be rejected or dropped and the receiver agent system 420 can be prevented from evaluating the query 415. For instance, the receiver agent system 420 will not use potentially computationally expensive evaluation of a machine-learned model to produce an output in response to the query 415. In some instances, the query 415 may be dropped without notification to the caller agent system 410. In some instances, a message indicating that the query 415 was rejected may be returned to the caller agent system 410 in place of or as the output 424 of the receiver agent system 420. In some instances, the message indicating that the query 415 was rejected may provide some information about why the query 415 was rejected. For example, the gating mechanism 425 and/or the receiver agent system 420 may return a message indicating that the region is not supported in response to a query 415 for booking travel accommodations in a region not serviced by the receiver agent system 420, or that the language is not supported for a query 415 in a language in which the agent system was not trained, or other suitable rejection message indicative of at least one reason for the rejection of the query 415. This information may be provided directly by the receiver agent system 420 and/or may be predicted by the gating mechanism 425 based on information about historical queries.

In some implementations, the gating mechanism 425 can employ a probabilistic condition having one of a first condition or a second condition in determining whether to provide the query 415 to the receiver agent system 420. For instance, in the first condition, the computing system 400 can communicate the query 415 to the receiver agent system 420 as input to the receiver agent system 420. For instance, the query 415 can bypass the gating mechanism 425 in the first condition. In the second condition, the query 415 can be provided to the gating mechanism 425 as input. For instance, in the second condition, the gating mechanism 425 can be employed to determine whether the query 415 can be handled by the receiver agent system 420.

In some instances, this probabilistic condition can be referred to as or controlled using a probability parameter (e.g., an “epsilon” parameter) that controls a tradeoff between exploring the ability of the receiver agent system 420 to handle various queries or query 415 types and exploiting the ability of the gating mechanism 425 to appropriately gate incoming queries. For example, a first condition can correspond to exploration and can occur with probability equal to the epsilon value; a second condition can correspond to exploitation and can occur with probability equal to one minus the epsilon value. The first, exploration-based condition can be useful for building a set of outcomes that assist in demonstrating the capabilities of the receiver agent system 420, including potential failure cases. This set of outcomes can then be used to refine the operations of the gating mechanism 425. The gating mechanism 425 can therefore assess and modify its own output over time.

In particular, in the first condition, the query 415 can be passed directly to the receiver agent system 420 (e.g., without being gated). The receiver agent system 420 can attempt to respond to these unfiltered queries, and can determine whether it could or could not handle the queries. In some implementations, the receiver agent system 420 or some other associated feedback system can produce a gating metric 422 indicative of whether the query 415 should or should not have been gated. For instance, the receiver agent system 420 may produce a confidence score descriptive of how a confidence of the receiver agent system 420 (and/or of machine-learned model(s) utilized by the receiver agent system 420) that the output 424 is responsive to the query 415. This condition can ensure that at least some unfiltered queries reach the receiver agent system 420, and the results of these queries can be used to tune the gating mechanism 425 to changes in the capability of the receiver agent system 420 over time. For example, the gating mechanism 425 may initially be configured to gate for a receiver agent system 420 that lacks the capability to book travel accommodations for a geographic region. If the capability of the receiver agent system 420 is later extended to allow booking in that region, the gating mechanism 425 should ideally allow queries for booking in that region to pass to the receiver agent system 420, whereas those queries may have been blocked in an earlier iteration of the gating mechanism 425. By adapting for the capabilities of the receiver agent system 420 over time, the gating mechanism 425 can provide for reflecting the actual capabilities of the receiver agent system 420 without unnecessarily gating otherwise valid queries.

Furthermore, in the second condition, the gating mechanism 425 is actively employed to determine whether to reject the query 415 or pass the query 415 to the receiver agent system 420. The query 415 can be provided to the gating mechanism 425 as input. The gating mechanism 425 can produce an output based on the query 415 as input. The query 415 can be provided to the receiver agent system 420 or gated based on the output of the gating mechanism 425.

In some implementations, when a condition occurs in one of the first or second condition, the gating mechanism 425 (or another element of a computing system) can evaluate a probabilistic condition to resolve the probabilistic condition to (e.g., only) one of the first or second condition with a respective probability for each condition based on the probabilistic parameter. The probabilistic condition may be evaluated by, for example, utilizing a random number generator or other nondeterministic algorithm to resolve the probabilistic condition. For example, in some implementations, a random number generator may produce a value within a range of possible values, with subsets of the range assigned to each of the conditions that may occur upon resolving the probabilistic condition. If the value produced by the random number generator falls within the subset of the range associated with a given condition (e.g., the first condition or the second condition), such as a range bounded by the probabilistic parameter, that condition can occur. Other manners of determining the occurrence of the first condition or the second condition can be employed without deviating from the present disclosure. Still further, it should be understood that the random number generator need not necessarily be truly random. For instance, a random number generator may utilize or execute one or more deterministic algorithm(s) that have quasi-random results, in that the values occur with a relatively predictable frequency and/or the value produced by the algorithm(s) can be different at each execution of the algorithm.

In some implementations, the gating mechanism 425 can include one or more gating parameters. For example, parameters described herein such as the distance threshold, an early exit condition, and parameters of a gating model of the gating mechanism 425 can be gating parameters. The computing system 400 can modify the gating parameters based on the gating metric 422. For example, in some implementations, the gating metric 422 can be or can include an indication of whether the query 415 should have been gated. If the gating mechanism 425 passes a query 415 to the receiver agent system 420 (e.g., in the second condition) that should have instead been blocked by the gating mechanism 425, the gating metric 422 can communicate a negative condition. The negative condition of the gating metric and the output of the gating mechanism 425 used to determine to pass the query 415 can suggest a false positive condition, where a query 415 was provided to the receiver agent system 420 that should not have been. As another example, if the gating mechanism 425 determines that a query 415 should be blocked, but the receiver agent system 420 satisfactorily handles the query 415 (e.g., in the first condition, where the query 415 bypasses the gating mechanism), the gating metric 422 can indicate a positive condition. In view of the output of the gating mechanism 425 supporting blocking the query 415, the gating metric 422 can be used to determine a false negative condition, where a query 415 would have been blocked but should not have been. The gating mechanism 425 can utilize information about true positives and true negatives as well as false positives and false negatives, which is available from the gating metric 422, to adjust its parameters to minimize false positives and negatives and/or maximize true positives and true negatives.

As another example, the computing system 400 can modify the probabilistic parameter based on the gating metric 422. For instance, if the gating mechanism 425 has consistently provided high true positives and true negatives, the probabilistic parameter may be modified such that the first condition appears less frequently, since the high amount of true positives and true negatives suggests a lessened benefit from “testing” the receiver agent system 420 with non-gated queries, at least in that instant. The probabilistic parameter may be modified such that the first condition appears more frequently after some time has elapsed, to ensure that the receiver agent system 420 receives at least an occasional ungated query.

In some implementations, the gating mechanism 425 is configured to obtain a set of representative examples defining or residing within a solution space over one or more indices. The set of representative examples can be representative of tasks the receiver agent system 420 is able to perform. For example, the receiver agent system 420 can curate the representative examples in the solution space from past queries that were successfully handled by the agent system. As another example, the representative examples can be or can include training data provided to the receiver agent system 420. To gate a query 415, the gating mechanism 425 can determine a representation of the query 415 in the solution space, determine a distance between the representation of the query 415 and the set of the representative examples in the solution space, and, based on the distance, determine whether the query 415 should be accepted or rejected. For instance, the distance may be compared to a distance threshold, and the query 415 may be rejected if the distance fails to satisfy the distance threshold.

In some implementations, the gating mechanism 425 can include a language analysis tool operable to verify that a syntax or a structure of the query 415 conforms to an expected syntax or an expected structure of inputs to the receiver agent system 420. For instance, in some implementations, the receiver agent system 420 can create a tool to analyze the structure of the query 415. As one example, a receiver agent system 420 trained to perform mathematical operations can create a tool to check that the syntax of the query 415 generally resembles an equation or mathematical problem. As another example, a receiver agent system 420 configured to evaluate computer code or data, formal text, or other data that conforms to one or more conventions, structures, and/or syntaxes can create a tool to verify that the query 415 conforms to the conventions, structures, and/or syntaxes that the receiver agent system 420 is trained to evaluate.

In some implementations, the gating mechanism 425 can include a machine-learned gating model. The machine-learned gating model may be smaller than the machine-learned model(s) of the receiver agent system 420. For example, the gating model may require fewer computing resources to operate than the receiver agent system 420. The machine-learned gating model can be configured to receive the query 415 as input and output, in response to receiving the query 415 as input, data indicative of whether the query 415 should be provided to the receiver agent system 420. As one example, in some implementations, the receiver agent system 420 (and/or the caller agent system 410) can be or can include a large language model (LLM) and/or a foundation model.

In some implementations, the receiver agent system 420 can be configured to provide training data to the machine-learned gating model. For instance, in some implementations, the training data can include one or more training examples labeled with data indicative of whether the receiver agent system 420 is capable of handling the training examples. The training examples can be curated from one or more prior queries to the receiver agent system 420.

In some implementations, the gating mechanism 425 can include an exit listener. The exit listener can be configured to listen for an early exit message from the agent system in response to a prior related query 415. For example, the receiver agent system 420 can be configured to provide the early exit message in response to producing an output having less than a desired predicted quality and prior to producing a complete output. As one example, the receiver agent system 420 may produce the early exit message if it recognizes that a confidence score associated with the prediction has dropped below a confidence threshold. The early exit message can be used to gate subsequent related queries based on the prior related query 415. For example, if the prior related query 415 is earlier in a longer series of related queries to the agent system, the gating mechanism 425 can gate some or all of the related queries in the series. In some implementations, the gating mechanism 425 may produce a probabilistic estimate over a sequence of queries to predict a likelihood of the sequence of calls becoming suitable for processing by the receiver agent system 420. The probabilistic estimate can be used to gate or allow the sequence of calls (e.g., by allowing the calls if the probabilistic estimate satisfies a range or threshold).

Furthermore, in some implementations, the gating mechanism 425 can be modified based on a current load of the receiver agent system 420. For example, in some implementations, the gating mechanism 425 can be made more restrictive under higher loads of the receiver agent system 420 and/or less restrictive under lower loads of the receiver agent system 420. As one example, the gating mechanism 425 can be made more restrictive by decreasing the epsilon parameter, requiring a stricter distance threshold for comparing the query 415 to representative examples, allowing early exit in an increased number of cases, and so on.

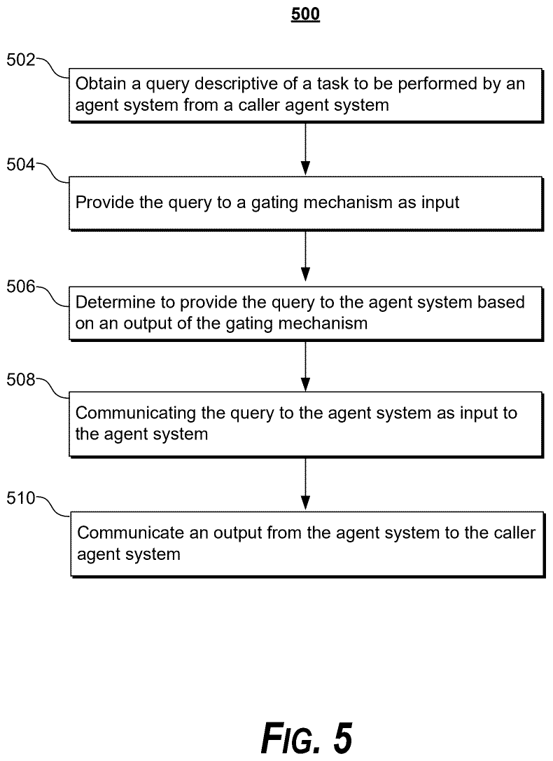

FIG. 5 depicts a flowchart of a method 500 for receiver-side gating of agent systems. One or more portion(s) of example method 500 can be implemented by a computing system that includes one or more computing devices such as, for example, computing systems described with reference to the other figures. Each respective portion of example method 500 can be performed by any (or any combination) of one or more computing devices. Moreover, one or more portion(s) of example method 500 can be implemented on the hardware components of the device(s) described herein, for example, to train one or more systems or models. FIG. 5 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 5 is described with reference to elements/terms described with respect to other systems and figures for exemplary illustrated purposes and is not meant to be limiting. One or more portions of example method 500 can be performed additionally, or alternatively, by other systems.

The method 500 can include, at 502, obtaining (e.g., by a gating mechanism) a query indicative of a task to be performed by an agent system (e.g., a receiver agent system). For instance, the query can be obtained (e.g., received) from a caller agent system. The receiver agent system may or may not be capable of performing the task. However, the capability of the receiver agent system to perform the task may not be immediately ascertainable to the receiver agent system. For instance, in some cases, the receiver agent system may only be able to evaluate its capability to perform the task during and/or after performance of the task. For example, in some implementations, the receiver agent system can evaluate a confidence score associated with its prediction or output. Evaluating the confidence score, however, may require that the receiver agent system performs at least a portion of the task.

The method 500 can include, at 504, providing the query to a gating mechanism as input. For instance, according to example aspects of the present disclosure, the gating mechanism can selectively gate queries from caller agent systems. For instance, at 506, the method 500 can include determining to provide the query to the agent system based on an output of the gating mechanism. For instance, in some example implementations, the gating mechanism can classify whether the call can be handled by the receiver agent system. The output (e.g., a classification) may have a first value (e.g., a first class) if the receiver agent system is capable of performing the task specified by the query. In some implementations, determining to provide the query to the agent system based on an output of the gating mechanism can include receiving the first output from the gating mechanism. For instance, the systems and methods herein can determine to provide the query to the gating mechanism in response to the output (e.g., the classification) having the first value (e.g., the first class). The gating mechanism can in some implementations classify the query early (e.g., prior to evaluating the query using the receiver agent system), efficiently, and accurately.

The method 500 can include, at 508, communicating the query to the agent system as input to the agent system. For instance, if the query can be handled, the gating mechanism can allow the query to pass to the receiver agent system. The receiver agent system can then handle the query with its full capabilities, e.g., by any machine-learned models and/or any tools associated with the machine-learned model(s).

The method 500 can include, at 510, communicating an output from the agent system to the caller agent system. For instance, the receiver agent system can produce the output in response to performing or handling the query. For example, if the query includes a request to answer a question or respond to a prompt, the output can be or can include a response to the question or prompt. As another example, if the query includes a request to book a travel accommodation, the output can be a message indicating that the booking was completed successfully, details about the booking, and so on.

However, if the query cannot be handled, the query can be rejected or dropped and the receiver agent system can be prevented from evaluating the query. As one example, in some implementations, the output of the gating mechanism may have a second value (e.g., a second class), the systems and methods herein can determine not to provide the query to the agent system (e.g., to gate or drop the query). For instance, the agent system will not use potentially computationally expensive evaluation of a machine-learned model to produce an output in response to the query. In some instances, the query may be dropped without notification to the caller agent system. In some instances, a message indicating that the query was rejected may be returned to the caller agent system in place of the output of the receiver agent system. In some instances, the message indicating that the query was rejected may provide some information about why the query was rejected. For example, the system may return a message indicating that the region is not supported in response to a query for booking travel accommodations in a region not serviced by the receiver agent system, or that the language is not supported for a query in a language in which the agent system was not trained, or other suitable rejection message indicative of at least one reason for the rejection of the query. This information may be provided directly by the receiver agent system and/or may be predicted by the gating mechanism based on information about historical queries.

In some implementations, the gating mechanism can include a language analysis tool operable to verify that a syntax or a structure of the query conforms to an expected syntax or an expected structure of inputs to the receiver agent system. For instance, in some implementations, the receiver agent system can create a tool to analyze the structure of the query. As one example, a receiver agent system trained to perform mathematical operations can create a tool to check that the syntax of the query generally resembles an equation or mathematical problem. As another example, a receiver agent system configured to evaluate computer code or data, formal text, or other data that conforms to one or more conventions, structures, and/or syntaxes can create a tool to verify that the query conforms to the conventions, structures, and/or syntaxes that the receiver agent system is trained to evaluate.

In some implementations, the gating mechanism can include a machine-learned gating model. The machine-learned gating model may be smaller than the machine-learned model(s) of the receiver agent system. For example, the gating model may require fewer computing resources to operate than the receiver agent system. The machine-learned gating model can be configured to receive the query as input and output, in response to receiving the query as input, data indicative of whether the query should be provided to the receiver agent system.

In some implementations, the gating mechanism can be modified based on a current load of the receiver agent system. For example, in some implementations, the gating mechanism can be made more restrictive under higher loads of the receiver agent system and/or less restrictive under lower loads of the receiver agent system. As one example, the gating mechanism can be made more restrictive by decreasing the epsilon parameter, requiring a stricter distance threshold for comparing the query to representative examples, allowing early exit in an increased number of cases, and so on.

In some implementations, the gating mechanism can include an exit listener. The exit listener can be configured to listen for an early exit message from the agent system in response to a prior related query. For example, the agent system can be configured to provide the early exit message in response to producing an output having less than a desired predicted quality and prior to producing a complete output. As one example, the agent system may produce the early exit message if it recognizes that a confidence score associated with the prediction has dropped below a confidence threshold. The early exit message can be used to gate subsequent related queries based on the prior related query. For example, if the prior related query is earlier in a longer series of related queries to the agent system, the gating mechanism can gate some or all of the related queries in the series. In some implementations, the gating mechanism may produce a probabilistic estimate over a sequence of queries to predict a likelihood of the sequence of calls becoming suitable for processing by the receiver agent system. The probabilistic estimate can be used to gate or allow the sequence of calls (e.g., by allowing the calls if the probabilistic estimate satisfies a range or threshold).

In some implementations, the gating mechanism can employ a probabilistic condition to determine whether to pass the query to the receiver agent system or gate the query. In some instances, this probabilistic condition can be referred to as or controlled using an “epsilon” parameter that controls a tradeoff between exploring the ability of the receiver agent system to handle various queries or query types and exploiting the ability of the gating mechanism to appropriately gate incoming queries. For example, a first condition can correspond to exploration and can occur with probability equal to the epsilon value; a second condition can correspond to exploitation and can occur with probability equal to one minus the epsilon value. The first, exploration-based condition can be useful for building a set of outcomes that assist in demonstrating the capabilities of the handling agent system, including potential failure cases. This set of outcomes can then be used to refine the operations of the gating mechanism. The gating mechanism can therefore assess and modify its own output over time.

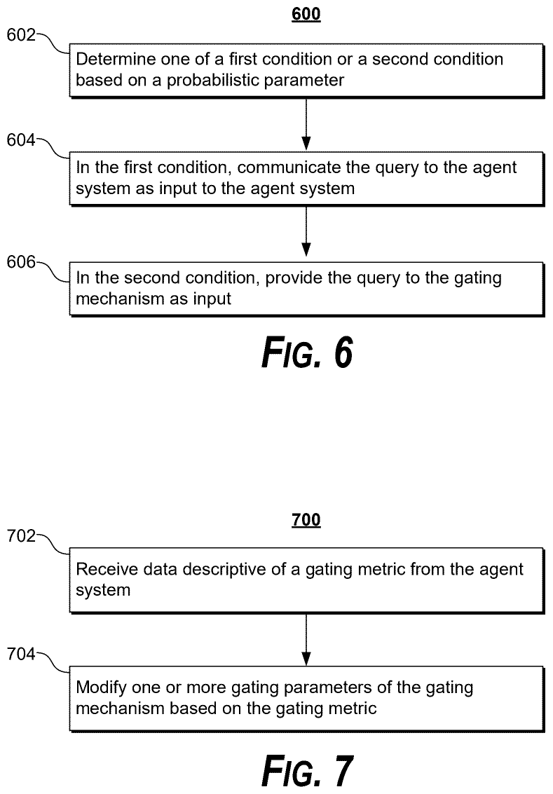

FIG. 6 depicts an example method 600 for determining to provide the query to the agent system. One or more portion(s) of example method 600 can be implemented by a computing system that includes one or more computing devices such as, for example, computing systems described with reference to the other figures. Each respective portion of example method 600 can be performed by any (or any combination) of one or more computing devices. Moreover, one or more portion(s) of example method 600 can be implemented on the hardware components of the device(s) described herein, for example, to train one or more systems or models. FIG. 6 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 6 is described with reference to elements/terms described with respect to other systems and figures for exemplary illustrated purposes and is not meant to be limiting. One or more portions of example method 600 can be performed additionally, or alternatively, by other systems.

The method 600 can include, at 602, determining one of a first condition or a second condition. For instance, in some implementations, when a condition occurs in one of the first or second condition, the gating mechanism (or another element of a computing system) can evaluate a probabilistic condition to resolve the probabilistic condition to (e.g., only) one of the first or second condition with a respective probability for each condition. The probabilistic condition may be evaluated by, for example, utilizing a random number generator or other nondeterministic algorithm to resolve the probabilistic condition. For example, in some implementations, a random number generator may produce a value within a range of possible values, with subsets of the range assigned to each of the conditions that may occur upon resolving the probabilistic condition. If the value produced by the random number generator falls within the subset of the range associated with a given condition (e.g., the first condition or the second condition), that condition can occur. Other manners of determining the occurrence of the first condition or the second condition can be employed without deviating from the present disclosure. Still further, it should be understood that the random number generator need not necessarily be truly random. For instance, a random number generator may utilize or execute one or more deterministic algorithm(s) that have quasi-random results, in that the values occur with a relatively predictable frequency and/or the value produced by the algorithm(s) can be different at each execution of the algorithm.

The method 600 can include, at 604, in the first condition, communicating the query to the agent system as input to the agent system. For instance, in the first condition, the query can be passed directly to the model agent system (e.g., without being gated). The agent system can attempt to respond to these unfiltered queries, and can determine whether it could or could not handle the queries.

In some implementations, in the first condition, the receiver agent system can receive the query regardless of whether the receiver agent system is capable of handling the query. These cases can ensure that the receiver agent system experiences at least an occasional bad query. Feedback from the receiver agent system in these cases can be useful for modifying the gating mechanism to more accurately reflect the present capabilities of the receiver agent system.

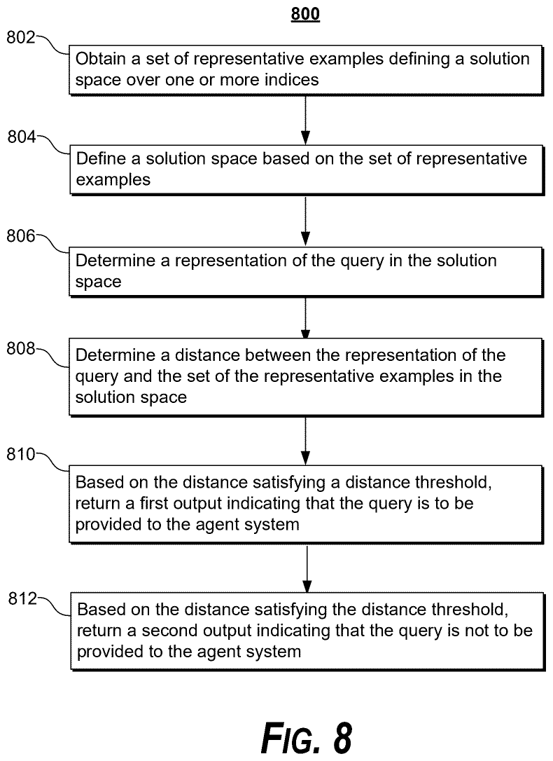

FIG. 7 depicts one example method 700 for modifying a gating mechanism according to example aspects of the present disclosure. One or more portion(s) of example method 700 can be implemented by a computing system that includes one or more computing devices such as, for example, computing systems described with reference to the other figures. Each respective portion of example method 700 can be performed by any (or any combination) of one or more computing devices. Moreover, one or more portion(s) of example method 700 can be implemented on the hardware components of the device(s) described herein, for example, to train one or more systems or models. FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 7 is described with reference to elements/terms described with respect to other systems and figures for exemplary illustrated purposes and is not meant to be limiting. One or more portions of example method 700 can be performed additionally, or alternatively, by other systems.

The method 700 can include, at 702, receiving data descriptive of a gating metric from the agent system. For instance, the receiver agent system or some other associated feedback system can produce a gating metric indicative of whether the query should or should not have been gated. For instance, the agent system may produce a confidence score descriptive of how a confidence of the agent system (and/or of machine-learned model(s) utilized by the agent system) that the output is responsive to the query. This condition can ensure that at least some unfiltered queries reach the agent system, and the results of these queries can be used to tune the gating mechanism to changes in the capability of the agent system over time. For example, a gating mechanism may initially be configured to gate for a model agent system that lacks the capability to book travel accommodations for a geographic region. If the capability of the agent system is later extended to allow booking in that region, the gating mechanism should ideally allow queries for booking in that region to pass to the agent system, whereas those queries may have been blocked in an earlier iteration of the gating mechanism. By adapting for the capabilities of the agent system over time, the gating mechanism can provide for reflecting the actual capabilities of the agent system without unnecessarily gating otherwise valid queries.

Returning to FIG. 6, the method 600 can include, at 606, in the second condition, providing the query to the gating mechanism as input. For instance, in the second condition, the gating mechanism can be actively employed to determine whether to reject the query or pass the query to the agent system. The query can be provided to the gating mechanism as input. The gating mechanism can produce an output based on the query as input. The query can be provided to the receiver agent system or gated based on the output of the gating mechanism.

Returning to FIG. 5, in some implementations, the gating mechanism can employ a gating vector index for determining the output of the gating mechanism. For instance, the gating mechanism can compare a representation of the query in a solution space to representations of curated examples to determine a similarity between the curated examples. The output of the gating mechanism can therefore convey information regarding the similarity between the curated examples, such as a classification or determination of adequate similarity between the query and the representative examples,

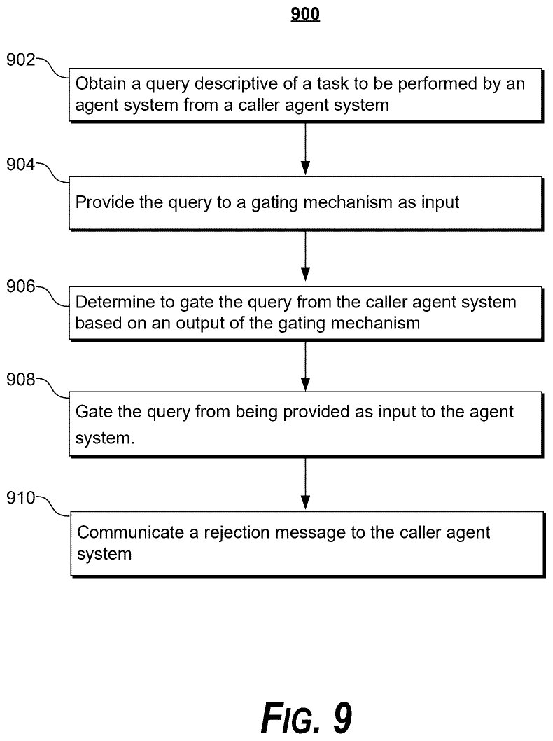

FIG. 8 depicts an example method 800 for generating an output of a gating mechanism according to example aspects of the present disclosure. FIG. 8 depicts one example method 800 for modifying a gating mechanism according to example aspects of the present disclosure. One or more portion(s) of example method 800 can be implemented by a computing system that includes one or more computing devices such as, for example, computing systems described with reference to the other figures. Each respective portion of example method 800 can be performed by any (or any combination) of one or more computing devices. Moreover, one or more portion(s) of example method 800 can be implemented on the hardware components of the device(s) described herein, for example, to train one or more systems or models. FIG. 8 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 8 is described with reference to elements/terms described with respect to other systems and figures for exemplary illustrated purposes and is not meant to be limiting. One or more portions of example method 800 can be performed additionally, or alternatively, by other systems.

The method 800 can include, at 802, obtaining a set of representative examples. For instance, the set of representative examples can be representative of tasks the receiver agent system is able to perform. For example, the receiver agent system can curate the representative examples from past queries that were successfully handled by the agent system. As another example, the representative examples can be or can include training data provided to the agent system.

The method 800 can include, at 804, defining a solution space based on the set of representative examples. For instance, the solution space can include a coordinate space having a plurality of dimensions. The representative examples can be projected into the solution space through a mapping function or system. For example, in some implementations, the representative examples can be input into a machine-learned embedding generation model. The embedding generation model can produce an embedding of the data received as input. For example, the embeddings of the representative examples can be a vector or tensor having a plurality of embedding values corresponding to coordinates along dimensions in the solution space. As another example, the solution space may be a geographical space (e.g., a map) indicative of locations (e.g., real-world locations) present in the representative examples. For example, if the receiving agent is configured to book travel accommodations, the representative examples and the solution space may define areas that the receiving agent is capable of booking travel accommodations for.

The method 800 can include, at 806, determining a representation of the query in the solution space. One example approach for determining a representation of the query in the solution space includes generating an embedding representation or vector representation of the query in the solution space. For example, in some implementations, the query (e.g., a query including text data) can be input into the machine-learned embedding generation model. The embedding generation model can produce a query embedding of the query received as input in a similar or identical manner to the embeddings of the representative examples. For example, the query embedding can be a vector or tensor having a plurality of embedding values corresponding to coordinates along dimensions in the solution space.

The method 800 can include, at 808, determining a distance between the representation of the query and the set of the representative examples in the solution space. The distance between the representation of the query and the set of representative examples in the solution space can be determined in any suitable fashion. As one example, the distance can refer to Euclidean distance (e.g., a distance defined by a line segment between the representation of the query and the set of representative examples in the solution space). In some implementations, the distance can be an aggregate distance. For example, the distance can be determined by summing or aggregating respective distances between the representation of the query and (e.g., each of) the representative examples in the solution space. As another example, in some implementations, the distance can be an average distance. For example, the distance can be determined by averaging respective distances between the representation of the query and (e.g., each of) the representative examples in the solution space. As another example, in some implementations, the distance can be a greatest distance or a maximum distance. For example, the distance can be determined by finding a greatest distance or a maximum distance between the representation of the query and the representative example that is farthest from the representation of the query in the solution space. As another example, in some implementations, the distance can be a least distance or a minimum distance. For example, the distance can be determined by finding a least distance or a minimum distance between the representation of the query and the representative example that is closest to the representation of the query in the solution space. References to extremes such as “maximum” or “minimum” should be understood to extend to other targeted positions in a hierarchical ordering based on value that are comparable to an extreme such as, for example, a “next-highest” position, “next-lowest” position, “second greatest” position, “second least” position, and so on. Other manners of determining the distance may be employed without departing from the present disclosure.

Based on the distance, the systems and methods described herein can determine whether the query should be accepted or rejected. For instance, the distance may be compared to a distance threshold, and the query may be rejected if the distance fails to satisfy (e.g., is greater than) the distance threshold. For instance, the method 800 can include, at 810, returning a first output indicating that the query is to be provided to the agent system based on the distance satisfying a distance threshold. Additionally and/or alternatively, the method 800 can include, at 812, returning a second output indicating that the query is not to be provided to the agent system based on the distance failing to satisfy the distance threshold.

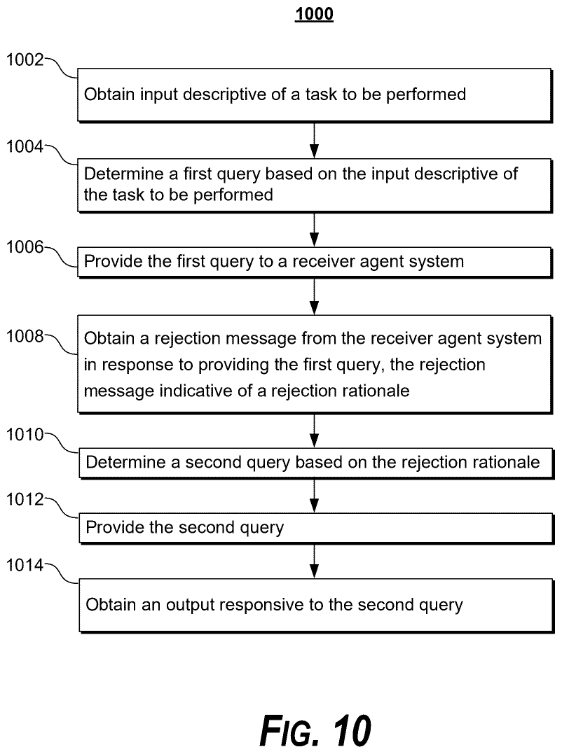

FIG. 9 depicts an example method 900 for generating an output of a gating mechanism according to example aspects of the present disclosure. FIG. 9 depicts one example method 900 for modifying a gating mechanism according to example aspects of the present disclosure. One or more portion(s) of example method 900 can be implemented by a computing system that includes one or more computing devices such as, for example, computing systems described with reference to the other figures. Each respective portion of example method 900 can be performed by any (or any combination) of one or more computing devices. Moreover, one or more portion(s) of example method 900 can be implemented on the hardware components of the device(s) described herein, for example, to train one or more systems or models. FIG. 9 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 9 is described with reference to elements/terms described with respect to other systems and figures for exemplary illustrated purposes and is not meant to be limiting. One or more portions of example method 900 can be performed additionally, or alternatively, by other systems.

The method 900 can include, at 902, obtaining (e.g., by a gating mechanism) a query indicative of a task to be performed by an agent system (e.g., a receiver agent system). For instance, the query can be obtained (e.g., received) from a caller agent system. The receiver agent system may or may not be capable of performing the task. However, the capability of the receiver agent system to perform the task may not be immediately ascertainable to the receiver agent system. For instance, in some cases, the receiver agent system may only be able to evaluate its capability to perform the task during and/or after performance of the task. For example, in some implementations, the receiver agent system can evaluate a confidence score associated with its prediction or output. Evaluating the confidence score, however, may require that the receiver agent system performs at least a portion of the task.

The method 900 can include, at 904, providing the query to a gating mechanism as input. For instance, according to example aspects of the present disclosure, the gating mechanism can selectively gate queries from caller agent systems. For instance, at 906, the method 900 can include determining to gate the query from the caller agent system based on an output of the gating mechanism. For instance, in some example implementations, the gating mechanism can classify whether the call can be handled by the receiver agent system. The output (e.g., a classification) may have a second value (e.g., a second class) if the receiver agent system is predicted as being incapable of performing the task specified by the query and/or if the query fails to conform to some requirement, such as a subject requirement, syntax requirement, or other requirement of the receiver agent system. In some implementations, determining to gate the query based on an output of the gating mechanism can include receiving the second output from the gating mechanism. For instance, the systems and methods herein can determine to provide the query to the gating mechanism in response to the output (e.g., the classification) having the second value (e.g., the second class). The gating mechanism can in some implementations classify the query early (e.g., prior to evaluating the query using the receiver agent system), efficiently, and accurately.

The method 900 can include, at 908, gating the query from being provided as input to the (e.g., receiver) agent system. For instance, gating the query can include discarding the query and/or otherwise blocking the query from causing an evaluation or computation at the agent system. For example, the query can be gated to prevent wasted computing resources associated with generating an output from the agent system in response to the query.

At 910, the method 900 can optionally include communicating a rejection message to the caller agent system. For instance, the rejection message may be communicated by the gating mechanism and/or the receiver agent system. In some implementations, the rejection message can be indicative of one or more rejection rationales. For example, the rejection rationale(s) can describe deficiencies in the query that caused it to be gated by the gating mechanism, such as requirements of the receiver agent system (e.g., syntax requirements, subject requirements, etc.) that the query failed to satisfy. As another example, in some implementations, the rejection message can simply indicate that the query was rejected. Still further, in some implementations, no rejection message may be communicated.

In some implementations, the receiver agent system can be utilized to generate the rejection message. For example, in some implementations, the gating mechanism may employ the language generation capabilities of the receiver agent system to encode the rejection rationales in the rejection message. In some implementations, the gating mechanism may employ a separate model (e.g., a smaller language model) to produce the rejection message.

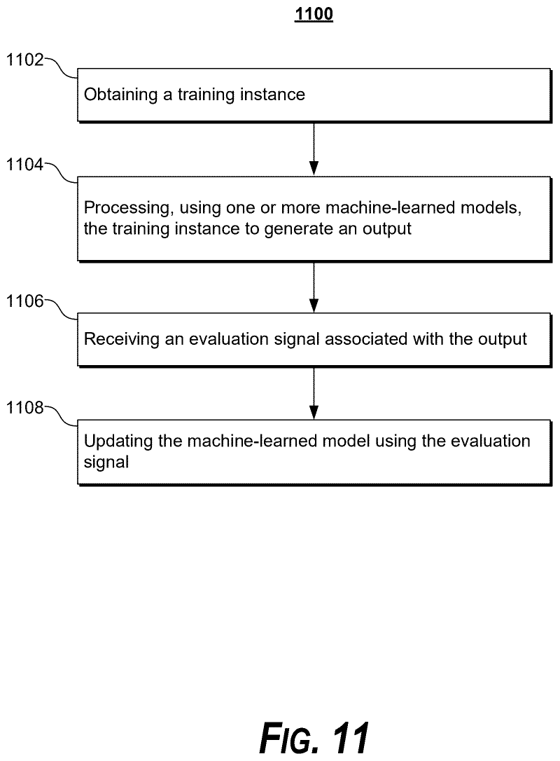

FIG. 10 depicts an example method 1000 for generating an output of a gating mechanism according to example aspects of the present disclosure. FIG. 10 depicts one example method 1000 for modifying a gating mechanism according to example aspects of the present disclosure. One or more portion(s) of example method 1000 can be implemented by a computing system that includes one or more computing devices such as, for example, computing systems described with reference to the other figures. Each respective portion of example method 1000 can be performed by any (or any combination) of one or more computing devices. Moreover, one or more portion(s) of example method 1000 can be implemented on the hardware components of the device(s) described herein, for example, to train one or more systems or models. FIG. 10 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 10 is described with reference to elements/terms described with respect to other systems and figures for exemplary illustrated purposes and is not meant to be limiting. One or more portions of example method 1000 can be performed additionally, or alternatively, by other systems.

The method 1000 can include, at 1002, obtaining (e.g., by a computing system including one or more computing devices) input descriptive of a task to be performed. For instance, the input can be received from a user. As one example, a user can speak, type, or otherwise provide instructions (e.g., via one or more user input devices) to the computing system. The instructions from the user can generally request that a task be performed. For example, the user input can describe the task to be performed similar to a spoken or typed phrase. As another example, the user input may include computer operations to be performed.

As used herein, a “user” can refer to a number of different entities including, but not limited to, a person, an individual, a corporation or corporate user, a legal entity or other defined entity, an administrator, a system manager, a computer-implemented user (e.g., an agent system, a debug user or testing user, etc.), and/or other suitable users. Furthermore, a user can be associated with one or more accounts and/or an account can be associated with one or more users. For instance, an account may be associated with one or more individuals that have access to (e.g., manage) the account, and the user may be the individuals themselves and/or the account. Furthermore, in some implementations, a user or account can be associated with one or more profiles. For example, an account may have a first profile associated with personal use and a second profile associated with business use.

The method 1000 can include, at 1004, determining (e.g., by the computing system) a first query based on the input descriptive of the task to be performed. The query can be a rephrasing of the task from the input such that the task may be understood by an agent system (e.g., a receiver agent system). In some implementations, the query may be identical to the user input. In some implementations, however, the task to be performed may be different from the task specified by a query. For example, the task specified by the user may require one or more subtasks to be completed, and the subtasks may be the tasks specified by the queries as described herein. Still further, in some implementations, the task to be performed according to the instructions may be similar or identical to the task requested by the query.

As one example, determining the first query can be performed using at least one machine-learned model and/or an agent system, such as a caller agent system. For example, in some implementations, the machine-learned model can be a large language model (LLM), foundation model, or similar machine-learned model that is operable to generate outputs in response to inputs. The outputs may resemble text or other human-generated content, but such outputs are not necessarily required in accordance with example aspects of the present disclosure. As one example, the machine-learned model can receive the input and predict or otherwise generate the first query in response to the input.

The method 1000 can include, at 1006, providing (e.g., by the computing system) the first query to a receiver agent system. For example, the computing system (e.g., acting as a caller agent system) may communicate the first query to the receiver agent system over one or more communication networks or through other suitable data transfer interface (e.g., a data bus).

In some implementations, providing the first query to the receiver agent system can include selecting the receiver agent system from a plurality of candidate receiver agent systems. For example, in some implementations, the caller agent system can be trained based on historical interactions and/or known capabilities with the candidate receiver agent systems such that the caller agent system can predict respective capability probabilities associated with the candidate receiver agent systems. The respective capability probabilities can be indicative of a probability that a respective candidate receiver agent system can adequately and/or reliably handle the task specified by the query. The caller agent system can then select the candidate receiver agent system with a high (e.g., the highest) probability of handling the task as the receiver agent system to provide the first query to. As explained further herein, the caller agent system's determination of which candidate receiver agent system to call may not necessarily always be accurate, especially in the case of changing capabilities of the candidate receiver agent systems or inadequate training data associated with some of the candidate receiver agent systems.

The method 1000 can include, at 1008, in response to providing the first query to the receiver agent system, obtaining (e.g., by the computing system) a rejection message. For instance, the rejection message can be communicated from the receiver agent system in response to the first query. The rejection message can be communicated by the receiver agent system when the first query is gated, as described further herein. For instance, the rejection message can be indicative of a rejection rationale. The rejection rationale can provide an explanation and/or potential corrections for conforming the first query to requirements and/or capabilities of the receiver agent system. As one example, if the receiver agent system is or includes an application programming interface (API) and the API requires a particular syntax to interact with, which the first query does not conform with, the rejection rationale can include an explanation of the syntax and/or how the first query does not conform with the syntax. In some implementations, the rejection rationale may not necessarily be complex. For instance, in some implementations, the rejection rationale may simply be that the query was rejected without requiring further explanation.

The method 1000 can include, at 1010, determining (e.g., by the computing system) a second query based on the rejection rationale. In some implementations, for example, the second query can be generated in a similar manner to the first query, such as by the machine-learned model(s). As one example, the second query can be generated by the machine-learned model(s) in response to receiving one or more of the rejection message, the first query, and/or the rejection rationale as input.

In some implementations, determining the second query based on the rejection rationale can include modifying (e.g., by the computing system) a content of the first query based on the rejection rationale. For example, in some implementations, the rejection rationale can be indicative of corrections that may be made to the first query to conform to requirements of the receiver agent system, such as syntax or API requirements, domain or subject requirements, or other suitable requirements or recommendations. The caller agent system can interpret these corrections or requirements and produce a new query having new content that complies with the corrections from the receiver agent system.

As one example, in some implementations, the rejection message can be used as training data to further refine predictions by the machine-learned model(s) used to generate the first query such that future predictions from those model(s) have a reduced likelihood of experiencing similar rejection rationales. For instance, in some implementations, determining the second query based on the rejection rationale can include providing (e.g., by the computing system) the rejection message to train one or more machine-learned model(s) used to generate the first query and determining (e.g., by the computing system) the second query using the machine-learned model(s) and subsequent to training the machine-learned model(s) using the rejection message. As one example, the rejection message may be used in a supervised training approach, such as where the training data includes the first query labeled with the rejection message, rejection rationale, or other (e.g., derived) label indicative of a deficiency in the first query. As another example, the first query and/or the rejection message may be used in an unsupervised training approach, such as that where the rejection message is provided (e.g., directly) as training data to the model(s).

The method 1000 can include, at 1012, providing, by the computing system, the second query. The method 1000 can further include, at 1014, obtaining (e.g., by the computing system) an output responsive to the second query. For example, in some implementations, the second query is not gated by its recipient such that the caller agent system can successfully obtain an output in response to the second query. In some implementations, the method 1000 can further include providing the output to a user, user device, or other requester.

In some implementations, the second query can be provided to a same recipient as the first query. For instance, in some implementations, providing the second query can include providing (e.g., by the computing system) the second query to the receiver agent system. Furthermore, in some implementations, obtaining the output responsive to the second query can include obtaining (e.g., by the computing system) the output from the receiver agent system. For example, in some implementations such as those where the rejection rationale is indicative of corrections that may be made to the first query, the caller agent system can determine to provide the second query (e.g., having the requested corrections) to the receiver agent system that provided the requested corrections.

In some implementations, however, the second query can be provided to a different receiver agent system than the first query. For instance, in some implementations, providing the second query can include providing (e.g., by the computing system) the second query to a second receiver agent system different from the receiver agent system. Additionally and/or alternatively, in some implementations, obtaining the output responsive to the second query comprises obtaining (e.g., by the computing system) the output from the second receiver agent system. For example, in some implementations, such as those where the receiver agent system in receipt of the first query is not able to perform the type of task described by the first query, the caller agent system may determine a second receiver agent system that is potentially capable of performing the task described by the query. For instance, the caller agent system may select another candidate receiver agent system with a high (e.g., second-highest) probability of successfully handling the query. In some implementations, for instance, determining the second query based on the rejection rationale can include modifying (e.g., by the computing system) a recipient of the first query from the receiver agent system to the second receiver agent system. In some implementations, the content of the second query may be similar or identical to that of the first query. For example, the first query may be resent to the second receiver agent system as the second query without substantive changes to content.

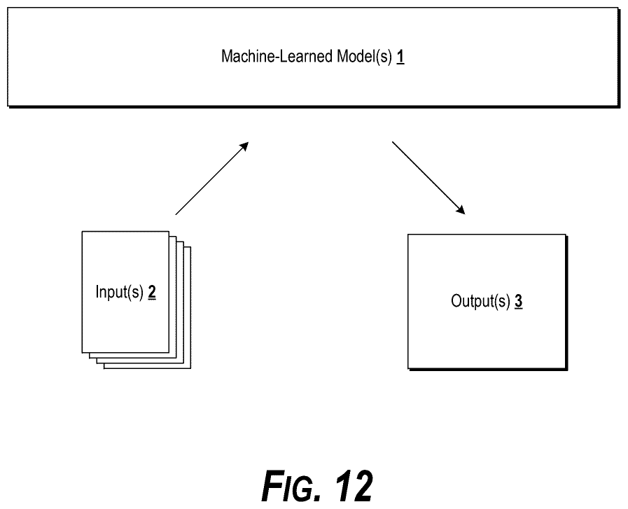

FIG. 11 depicts a flowchart of a method 1100 for training one or more machine-learned models according to aspects of the present disclosure. For instance, an example machine-learned model can include, be included in, or otherwise be utilized by the agent systems described herein. One or more portion(s) of example method 1100 can be implemented by a computing system that includes one or more computing devices such as, for example, computing systems described with reference to the other figures. Each respective portion of example method 1100 can be performed by any (or any combination) of one or more computing devices. Moreover, one or more portion(s) of example method 1100 can be implemented on the hardware components of the device(s) described herein, for example, to train one or more systems or models. FIG. 11 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 11 is described with reference to elements/terms described with respect to other systems and figures for exemplary illustrated purposes and is not meant to be limiting. One or more portions of example method 1100 can be performed additionally, or alternatively, by other systems.

At 1102, example method 1100 can include obtaining a training instance. A set of training data can include a plurality of training instances divided between multiple datasets (e.g., a training dataset, a validation dataset, or testing dataset). A training instance can be labeled or unlabeled. Although referred to in example method 1100 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 1104, example method 1100 can include processing, using one or more machine-learned models, the training instance to generate an output. The output can be directly obtained from the one or more machine-learned models or can be a downstream result of a chain of processing operations that includes an output of the one or more machine-learned models.

At 1106, example method 1100 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi-or self-supervised learning), or without labels (e.g., unsupervised learning). The evaluation signal can be a reward (e.g., for reinforcement learning). In some implementations, the reward can be computed using a machine-learned reward model configured to generate rewards based on output(s) received. For instance, the reward can be computed using feedback data describing human feedback on the output(s). As another example, in some implementations, the evaluation signal can be computed directly by the machine-learned model(s) that generate the output.

At 1108, example method 1100 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 1100 can include implementing a number of generalization techniques (e.g., weight decays, dropouts, etc.) to improve the generalization capability of the models being trained.

In some implementations, example method 1100 can be implemented for training a machine-learned model from an initialized state to a fully trained state (e.g., when the model exhibits a desired performance profile, such as based on accuracy, precision, recall, etc.).

In some implementations, example method 1100 can be implemented for particular stages of a training procedure. For instance, in some implementations, example method 1100 can be implemented for pre-training a machine-learned model. Pre-training can include, for instance, large-scale training over potentially noisy data to achieve a broad base of performance levels across a variety of tasks/data types.

In some implementations, example method 1100 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). In some implementations, example method 1100 uses adapter modules. Adapters can be small trainable layers that are inserted between pre-existing layers of a pre-trained model. During the fine-tuning process, the original parameters of the pre-trained model are typically frozen, and only the parameters of the adapters are updated.

In some implementations, example method 1100 can be implemented to execute parameter-efficient fine-tuning methods, such as Layerwise Optimization of Residuals (LoRA). LoRA can refine pre-trained models with minimal adjustments to the original parameters. This can be achieved by introducing trainable low-rank matrices that modify the behavior of the pre-trained weights without directly altering them. In some implementations, during fine-tuning, only these auxiliary matrices are updated, which significantly reduces the number of parameters that are trained.

An example fine-tuning approach includes reinforcement learning. Reinforcement learning can be based on user feedback on model performance during use.

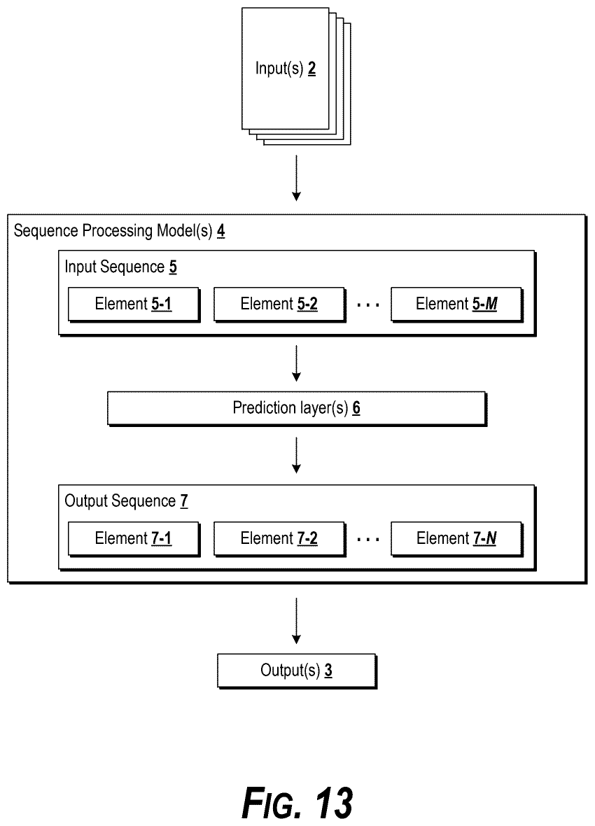

FIG. 12 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Machine-learned model(s) 1 can be or include, or otherwise be representative of any one or more of the machine-learned models described above with respect to the preceding figures. Although various features, variations, and implementations described below are described with respect to machine-learned model(s) 1, it is to be understood that such features, variations, and implementations are to be understood as described with respect to each of the machine-learned models or any other machine-learned component described herein.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include multiple different models or multiple different model portions configured to operate on data from input(s) 2.

Machine-learned model(s) 1 can include an ensemble of different models that can cooperatively interact to process data from input(s) 2. For example, a model ensemble can include multiple models that have different attributes (e.g., different architectures, trained with different recipes, etc.). The ensemble can output an overall output based on the individual outputs of the constituent models. In this manner, for instance, the diverse constituent models can work together to provide system-level robustness by effectively aggregating over individual strengths and weaknesses of any given model. The respective individual outputs can be combined in a weighted combination, using a voting or routing mechanism, or a learned output layer (e.g., one or more feedforward or fully-connected layers).

Machine-learned model(s) 1 can employ a mixture-of-experts structure. See, e.g., Zhou et al., Mixture-of-Experts with Expert Choice Routing, ARXIV: 2202.09368v2 (Oct. 14, 2022). For example, different portions of a model can learn (explicitly or implicitly) different expertise areas, with pathways through the model being selected by a learned routing mechanism that engages the appropriate expert for a given input (e.g., a given portion of an input, such as on a per-token basis). For example, a feedforward network can be sparsely activated for a given portion of an input based on an output of a routing mechanism that processes the portion of the input. In this manner, for instance, the group of activated weights can form an “expert” that is selected by the router. On each forward pass, only a subset of the total model weights may be engaged, thereby decreasing a quantity of operations performed for processing a given input compared to a densely activated model. In this manner, for instance, the expressive and interpretive power of a high-parameter-count model can be achieved with more compute-efficient forward passes.

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

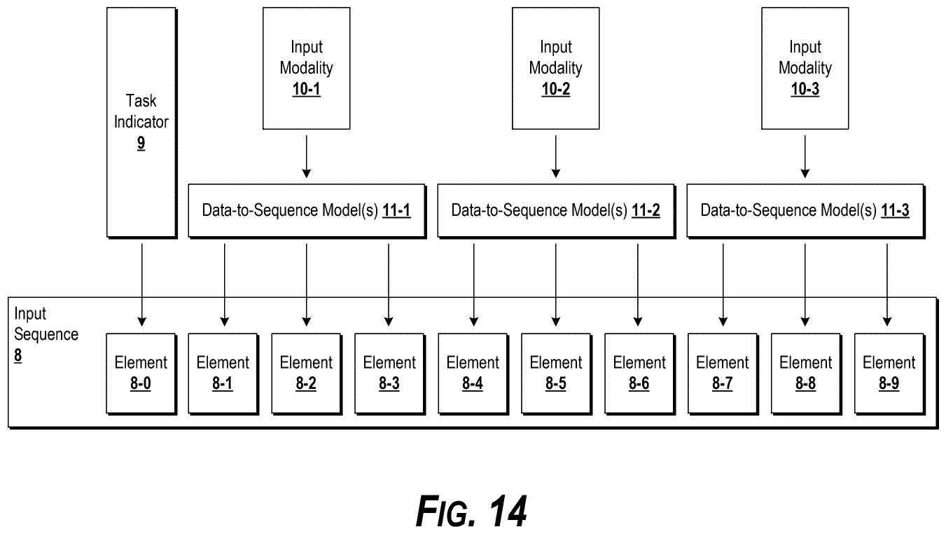

FIG. 13 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2,. 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV:2010.11929v2 (Jun. 3, 2021), audio domains, see, e.g., Agostinelli et al., MusicLM: Generating Music From Text, ARXIV: 2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 13 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV: 1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV: 2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

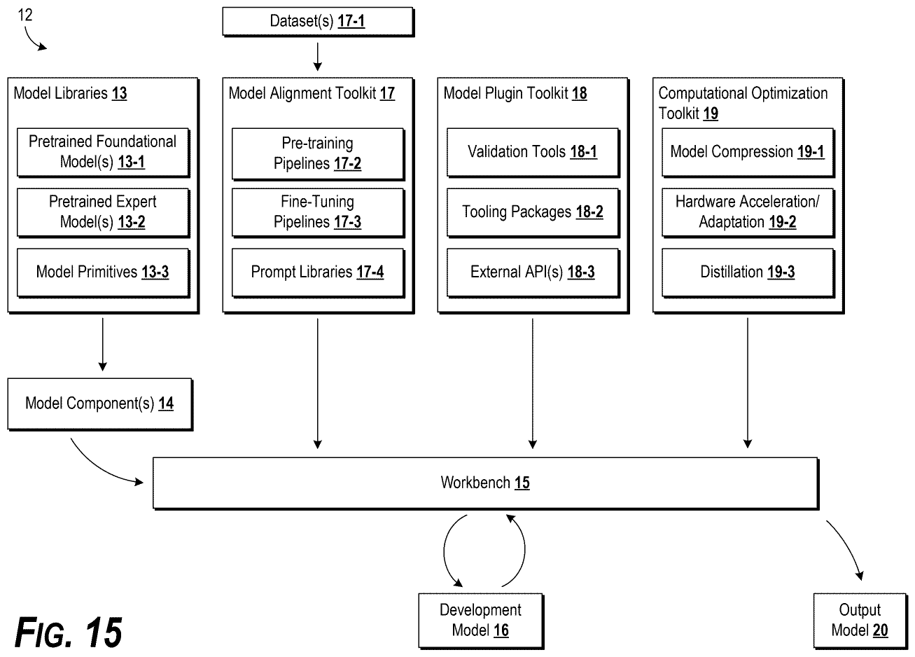

FIG. 14 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

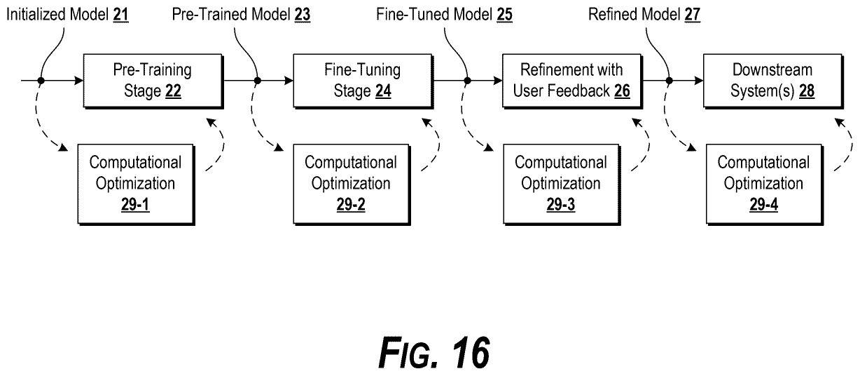

FIG. 15 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired. Model primitives 13-3 can include a library of pre-trained adapters or LoRA modules that can adapt a baseline foundational model to align its outputs with a desired performance profile, augment model capabilities (e.g., to adapt to a different input modality, etc.), and the like.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 1300 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for caller external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

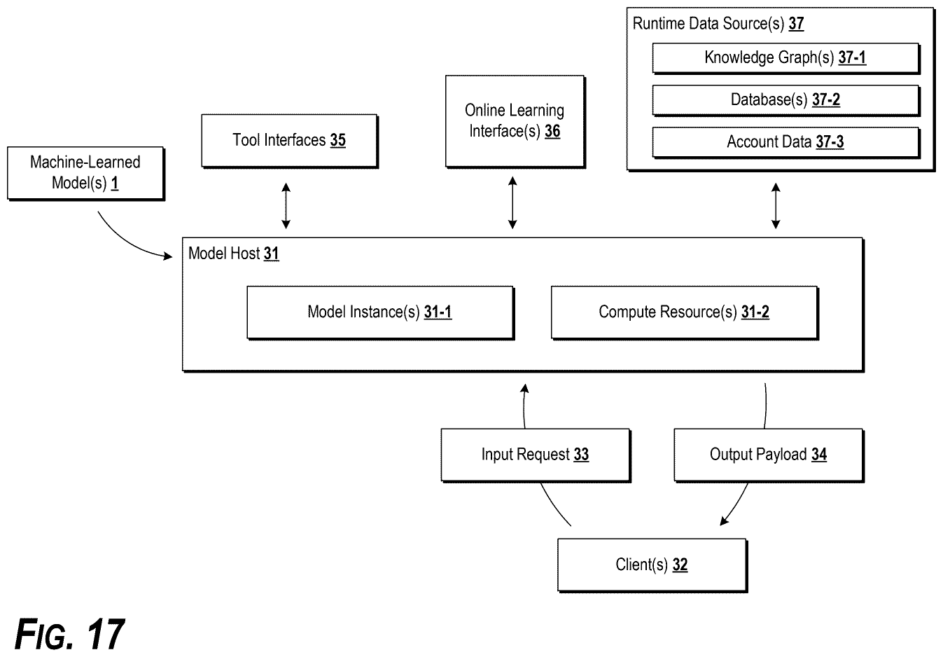

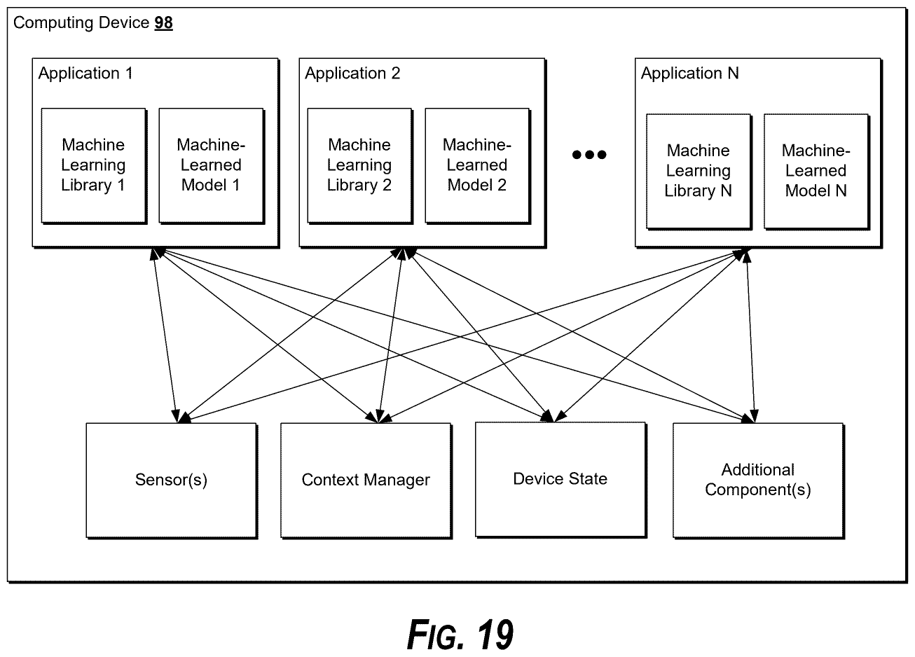

FIG. 16 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 18 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 18 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1,. 29-4 can all be the same, all be different, or include at least some different optimization techniques.

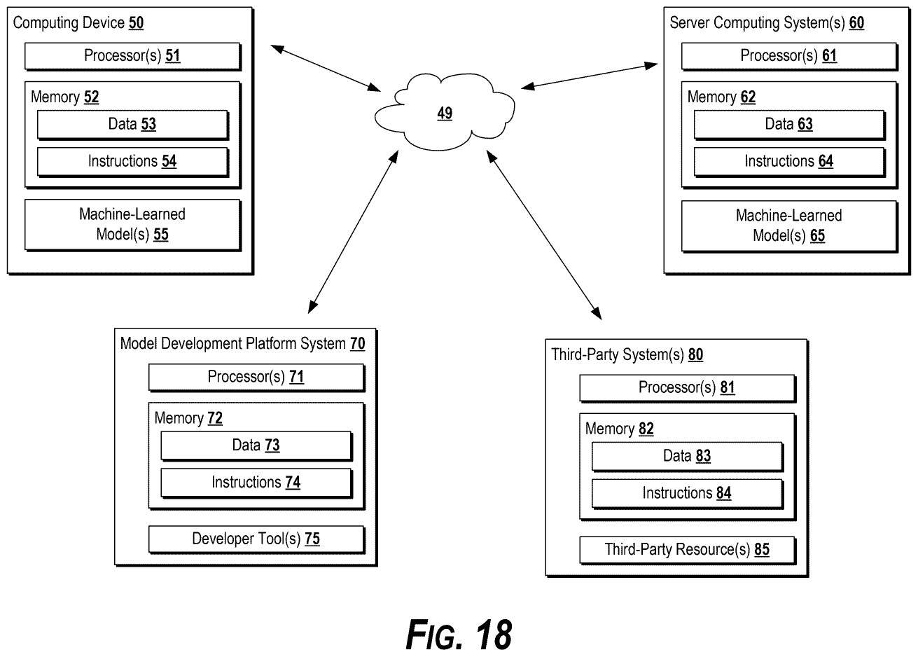

FIG. 17 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored on or in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can access a library of pre-trained adapters or LoRA modules that can adapt a baseline model to align its outputs with a desired performance profile, augment model capabilities (e.g., to adapt to a different input modality, etc.), and the like. For instance, model host 31 can receive an input request to load a customized model, and model host 31 can retrieve one or more components to adapt a baseline model to the custom profile. Model host 31 can determine that a particular functionality is needed for a particular task (e.g., based on an output of a model that preprocesses an input) and retrieve a pre-trained component accordingly.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g., one or more images or videos), the output comprises compressed visual data, and the task is a visual data compression task. In another example, the task may comprise generating an embedding for input data (e.g., input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

FIG. 18 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 18 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, Light Detection and Ranging system (LIDAR), a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, random access memory (RAM), read-only memory (ROM), EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 18 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

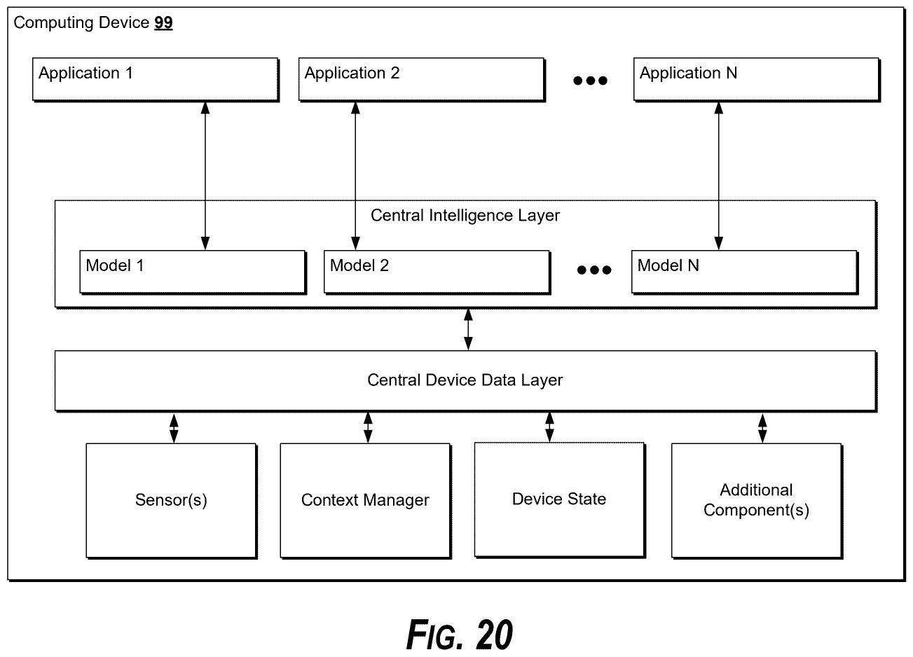

FIG. 19 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 19, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

FIG. 20 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 20, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 20, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of,” “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method of gating requests to agent systems, the method comprising:
obtaining, by a computing system comprising one or more computing devices, a query descriptive of a task to be performed by an agent system from a caller agent system;
providing, by the computing system, the query to a gating mechanism as input;
determining, by the computing system, to provide the query to the agent system based on an output of the gating mechanism;
in response to determining to provide the query to the agent system, communicating, by the computing system, the query to the agent system as input to the agent system; and
communicating, by the computing system, an output from the agent system to the caller agent system.

2. The computer-implemented method of claim 1, wherein the agent system comprises a large language model (LLM) or foundation model.

3. The computer-implemented method of claim 1, wherein the gating metric comprises a confidence score descriptive of confidence that the agent system successfully handled the task described by the query.

4. The computer-implemented method of claim 1, wherein the method further comprises:
determining, by the computing system, one of a first condition or a second condition based on a probabilistic parameter, wherein the computing system has the first condition with a likelihood defined by the probabilistic parameter and the computing system has the second condition if the computing system does not have the first condition;
in the first condition, communicating, by the computing system, the query to the agent system as input to the agent system; and
in the second condition, providing, by the computing system, the query to the gating mechanism as input.

5. The computer-implemented method of claim 4, wherein the method further comprises modifying, by the computing system, the probabilistic parameter based on the gating metric.

6. The computer-implemented method of claim 1, further comprising:
receiving, by the computing system, data descriptive of a gating metric from the agent system, the gating metric indicative of a correlation between the task of the query and the output of the agent system; and
modifying, by the computing system, one or more gating parameters of the gating mechanism based on the gating metric.

7. The computer-implemented method of claim 1, wherein the gating mechanism is configured to:
obtain a set of representative examples, the set of representative examples being representative of tasks the agent system is able to perform;
define a solution space based on the set of representative examples;
determine a representation of the query in the solution space;
determine a distance between the representation of the query and the set of the representative examples in the solution space;
based on the distance satisfying a distance threshold, return a first output indicating that the query is to be provided to the agent system; and
based on the distance failing to satisfy the distance threshold, return a second output indicating that the query is not to be provided to the agent system.

8. The computer-implemented method of claim 7, wherein determining, by the computing system, to provide the query to the agent system based on an output of the gating mechanism comprises receiving the first output from the gating mechanism.

9. The computer-implemented method of claim 1, wherein the gating mechanism comprises a language analysis tool operable to verify that a syntax or a structure of the query conforms to an expected syntax or an expected structure of inputs to the agent system.

10. The computer-implemented method of claim 9, wherein the language analysis tool is generated by the agent system.

11. The computer-implemented method of claim 1, wherein the gating mechanism comprises a machine-learned gating model configured to receive the query as input and output, in response to receiving the query as input, data indicative of whether the agent system is capable of handling the query.

12. The computer-implemented method of claim 11, wherein the agent system is configured to provide training data to the machine-learned gating model; and
wherein the training data comprises one or more training examples labeled with data indicative of whether the agent system is capable of handling the training examples.

13. The computer-implemented method of claim 12, wherein the one or more training examples are curated from one or more prior queries to the agent system.

14. The computer-implemented method of claim 1, wherein the gating mechanism comprises an exit listener, the exit listener configured to listen for an early exit message from the agent system in response to a prior related query;
wherein the agent system is configured to provide the early exit message in response to producing an output having a predicted quality that fails to satisfy a predicted quality threshold, and prior to producing a complete output.

15. The computer-implemented method of claim 1, wherein the method further comprises modifying the gating mechanism based on a current load of the agent system.

16. The computer-implemented method of claim 1, wherein the agent system comprises a receiver agent system.

17. The computer-implemented method of claim 1, wherein the method further comprises:
obtaining, by the computing system, a second query descriptive of a second task to be performed by the agent system from the caller agent system;
providing, by the computing system, the second query to the gating mechanism as input;
determining, by the computing system, to gate the query from the caller agent system based on an output of the gating mechanism; and
in response to determining to provide the query to the agent system, gating, by the computing system, the query from being provided as input to the agent system.

18. A computing system, comprising:
one or more processors; and
one or more non-transitory, computer-readable media storing instructions that, when implemented, cause the one or more processors to perform operations, the operations comprising:
obtaining a query descriptive of a task to be performed by an agent system from a caller agent system;
providing the query to a gating mechanism as input;
determining to provide the query to the agent system based on an output of the gating mechanism;
in response to determining to provide the query to the agent system, communicating the query to the agent system as input to the agent system; and
communicating an output from the agent system to the caller agent system.

19. The computing system of claim 18, wherein the operations further comprise determining one of a first condition or a second condition based on a probabilistic parameter, wherein the computing system has the first condition with a likelihood defined by the probabilistic parameter and the computing system has the second condition if the computing system does not have the first condition;
in the first condition, communicating the query to the agent system as input to the agent system; and
in the second condition, providing the query to the gating mechanism as input.

20. The computing system of claim 18, wherein the gating mechanism is configured to:
obtain a set of representative examples, the set of representative examples being representative of tasks the agent system is able to perform;
define a solution space based on the set of representative examples;
determine a representation of the query in the solution space;
determine a distance between the representation of the query and the set of the representative examples in the solution space;
based on the distance satisfying a distance threshold, return a first output indicating that the query is to be provided to the agent system; and
based on the distance failing to satisfy the distance threshold, return a second output indicating that the query is not to be provided to the agent system.

21. One or more non-transitory, computer-readable media storing instructions that, when implemented, cause one or more processors to perform operations, the operations comprising:
obtaining a query descriptive of a task to be performed by an agent system from a caller agent system;
providing the query to a gating mechanism as input;
determining to gate the query from the caller agent system based on an output of the gating mechanism; and
in response to determining to provide the query to the agent system, gating the query from being provided as input to the agent system.

22. The one or more non-transitory, computer-readable media of claim 21, wherein the operations further comprise determining one of a first condition or a second condition based on a probabilistic parameter, wherein the first condition occurs with a chance defined by the probabilistic parameter and the second condition occurs if the first condition does not occur;
in the first condition, communicating the query to the agent system as input to the agent system; and
in the second condition, providing the query to the gating mechanism as input.

23. The one or more non-transitory, computer-readable media of claim 21, wherein the operations further comprise communicating a rejection message from the gating mechanism to the caller agent system.

24. A computer-implemented method, comprising:
obtaining, by a computing system comprising one or more computing devices, input descriptive of a task to be performed;
determining, by the computing system, a first query based on the input descriptive of the task to be performed;
providing, by the computing system, the first query to a receiver agent system;
in response to providing the first query to the receiver agent system, obtaining, by the computing system, a rejection message indicative of a rejection rationale;
determining, by the computing system, a second query based on the rejection rationale;
providing, by the computing system, the second query; and
obtaining, by the computing system, an output responsive to the second query.

25. The computer-implemented method of claim 24, wherein providing the second query comprises providing, by the computing system, the second query to the receiver agent system; and
wherein obtaining the output responsive to the second query comprises obtaining, by the computing system, the output from the receiver agent system.

26. The computer-implemented method of claim 24, wherein determining the second query based on the rejection rationale comprises modifying, by the computing system, a content of the first query based on the rejection rationale.

27. The computer-implemented method of claim 24, wherein providing the second query comprises providing the second query to a second receiver agent system different from the receiver agent system; and
wherein obtaining the output responsive to the second query comprises obtaining, by the computing system, the output from the second receiver agent system.

28. The computer-implemented method of claim 27, wherein determining the second query based on the rejection rationale comprises modifying, by the computing system, a recipient of the first query from the receiver agent system to the second receiver agent system.

29. The computer-implemented method of claim 24, wherein determining the second query based on the rejection rationale comprises:
providing, by the computing system, the rejection message to train a machine-learned model used to generate the first query; and
determining, by the computing system, the second query using the machine-learned model and subsequent to training the machine-learned model using the rejection message.
